(19) United States
(12) Patent Application Publication
(10) Pub. No.: US 2021/0166484 A1
(43) Pub. Date: Jun. 3, 2021

(54) XR DEVICE AND METHOD FOR CONTROLLING THE SAME

(71) Applicant: LG ELECTRONICS INC., Seoul (KR)

(72) Inventors: Insuk KIM, Seoul (KR); Hyewon SEO, Seoul (KR); Jeeyoung CHEON, Seoul (KR); Hyunjoo LEE, Seoul (KR)

(73) Assignee: LG ELECTRONICS INC., Seoul (KR)

(21) Appl. No.: 16/818,737

(22) Filed: Mar. 13, 2020

(30) Foreign Application Priority Data
Dec. 3, 2019 (KR) 10-2019-0159215

(51) Int. Cl. G06T 19/00; G06F 3/0481; G06K 9/00

(52) U.S. Cl. CPC G06T 19/006; G06K 9/00664; G06F 3/04815

(57) ABSTRACT

The present disclosure relates to an XR device and method of controlling the same, including projecting a virtual User Interface (UI) including a plurality of control components for operation control of a communication-connected external device on a projection plane and changing disposition of the control components based on a state of the projection plane having the virtual UI projected thereon.

This application claims the benefit of Korean Patent Application No. 10-2019-0159215, filed on Dec. 3, 2019, which is hereby incorporated by reference as if fully set forth herein.

### BACKGROUND OF THE INVENTION

### Field of the Invention

The present disclosure relates to an extended reality (XR) device for providing augmented reality (AR) mode and virtual reality (VR) mode and a method of controlling the same. More particularly, the present disclosure is applicable to all of the technical fields of 5^{th} generation (5G) communication, robots, self-driving, and artificial intelligence (AI).

### Discussion of the Related Art

Virtual reality (VR) simulates objects or a background in the real world only in computer graphic (CG) images. Augmented reality (AR) is an overlay of virtual CG images on images of objects in the real world. Mixed reality (MR) is a CG technology of merging the real world with virtual objects. All of VR, AR and MR are collectively referred to shortly as extended reality (XR).

XR technology may be applied to a Head-Mounted Display (HMD), a Head-Up Display (HUD), eyeglasses-type glasses, a mobile phone, a tablet, a laptop, a desktop computer, a TV, digital signage, etc. A device to which XR technology is applied may be referred to as an XR device.

When a projection of the related art connects communication with an Internet-of-Things (IoT) device at home, it just projects information related to the IoT device on a projection plane but has a problem of failing to provide a user with various functions related to the IoT device.

### SUMMARY OF THE INVENTION

Accordingly, the present disclosure is directed to an XR device and method for controlling the same that substantially obviate one or more problems due to limitations and disadvantages of the related art.

One object of one embodiment of the present disclosure is to provide an XR device and method for controlling the same, by which an operation of an external device is controllable through user's manipulations of control components in a manner of projecting a virtual User Interface (UI) including two or more control components for the operation control of the communication-connected external device on a projection plane.

Another object of one embodiment of the present disclosure is to provide an XR device and method for controlling the same, by which disposition of the control components are changed according to a state of the projection plane on which the virtual UI is projected.

Further object of one embodiment of the present disclosure is to provide an XR device and method for controlling the same, by which disposition of the control components are changed so as to enable the control components to be projected in a manner of avoiding an object existing at a position on which the virtual UI will be projected in the projection plane.

Another further object of one embodiment of the present disclosure is to provide an XR device and method for controlling the same, by which the control components are projected so as to prevent the control components from being viewed distortedly according to a material state of the projection plane.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the disclosure, as embodied and broadly described herein, an XR device according to one embodiment of the present disclosure may include a communication module communicating with at least one external device, a projection module projecting a virtual User Interface (UI) including a plurality of control components for operation control of the external device on a projection plane, a camera receiving an image including a touch action of a user on the control components projected on the projection plane, and a processor configured to control the external device to perform an operation related to the control component touched by the user based on the captured image, wherein the processor may be further configured to change disposition of the control components based on a state of the projection plane.

In another aspect of the present disclosure, as embodied and broadly described herein, a method of controlling an XR device having a transparent display according to another embodiment of the present disclosure may include connecting communication with at least one external device through a communication module, projecting a virtual User Interface (UI) including a plurality of control components for operation control of the external device on a projection plane through a projection module, receiving an image including a user's touch action on the control components projected on the projection plane through a camera, controlling the external device to perform an operation related to the control component touched by the user based on the captured image, and changing disposition of the control components projected on the projection plane based on a state of the projection plane.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram illustrating an artificial intelligence (AI) device 1000 according to an embodiment of the present disclosure.

FIG. 2 is a block diagram illustrating an AI server 1120 according to an embodiment of the present disclosure.

FIG. 3 is a diagram illustrating an AI system according to an embodiment of the present disclosure.

FIG. 4 is a block diagram illustrating an extended reality (XR) device according to embodiments of the present disclosure.

FIG. 5 is a detailed block diagram illustrating a memory illustrated in FIG. 4.

FIG. 6 is a block diagram illustrating a point cloud data processing system.

FIG. 7 is a block diagram illustrating an XR device 1600 including a learning processor.

FIG. 8 is a flowchart illustrating a process of providing an XR service by an XR device 1600 of the present disclosure, illustrated in FIG. 7.

FIG. 9 is a diagram illustrating the outer appearances of an XR device and a robot.

FIG. 10 is a flowchart illustrating a process of controlling a robot by using an XR device.

FIG. 11 is a diagram illustrating a vehicle that provides a self-driving service.

FIG. 12 is a flowchart illustrating a process of providing an augmented reality/virtual reality (AR/VR) service during a self-driving service in progress.

FIG. 13 is a conceptual diagram illustrating an exemplary method for implementing an XR device using an HMD type according to an embodiment of the present disclosure.

FIG. 14 is a conceptual diagram illustrating an exemplary method for implementing an XR device using AR glasses according to an embodiment of the present disclosure

FIG. 15 is a diagram showing a case of implementing an XR device of an AR projector type according to one embodiment of the present disclosure.

FIG. 16 is a block diagram of an AR projector according to one embodiment of the present disclosure.

FIG. 17 is a flowchart of a projection control process of a virtual UI of an AR projector according to one embodiment of the present disclosure.

FIG. 18 is a diagram to describe a process for projecting a virtual UI according to one embodiment of the present disclosure.

FIG. 19 is a diagram to describe a process for projecting control components within a virtual UI in a manner of avoiding an object according to one embodiment of the present disclosure.

FIG. 20 is a diagram to describe a process for projecting some of control components within a virtual UI on an object according to one embodiment of the present disclosure.

FIG. 21 is a diagram showing a process for projecting some of control components within a virtual UI in a manner of avoiding a dangerous object according to one embodiment of the present disclosure.

FIG. 22 is a diagram to describe a process for enlarging and projecting some of control components within a virtual UI according to one embodiment of the present disclosure.

FIG. 23 is a diagram to describe a process for displaying a virtual UI on an external device having a screen according to one embodiment of the present disclosure.

FIG. 24 is a diagram to describe a process for projecting a virtual UI to control a non-screen external device located in a projection plane according to one embodiment of the present disclosure.

FIG. 25 is a diagram to describe a process for linking a virtual UI to an object according to one embodiment of the present disclosure.

FIG. 26 is a diagram to describe a process for changing a projection angle of a virtual UI depending on a user's location according to one embodiment of the present disclosure.

FIG. 27 is a diagram to describe a process for projecting a virtual UO on a material of a curved projection plane according to one embodiment of the present disclosure.

FIG. 28 is a diagram to describe a process for changing a projection position of a virtual UI depending on a material of a projection plane according to one embodiment of the present disclosure.

FIG. 29 is a diagram to describe a process for changing a display style of a virtual UI depending on a material color of a projection plane according to one embodiment of the present disclosure.

### DESCRIPTION OF SPECIFIC EMBODIMENTS

Reference will now be made in detail to embodiments of the present disclosure, examples of which are illustrated in the accompanying drawings. Wherever possible, the same reference numbers will be used throughout the drawings to refer to the same or like parts, and a redundant description will be avoided. The terms “module” and “unit” are interchangeably used only for easiness of description and thus they should not be considered as having distinctive meanings or roles. Further, a detailed description of well-known technology will not be given in describing embodiments of the present disclosure lest it should obscure the subject matter of the embodiments. The attached drawings are provided to help the understanding of the embodiments of the present disclosure, not limiting the scope of the present disclosure. It is to be understood that the present disclosure covers various modifications, equivalents, and/or alternatives falling within the scope and spirit of the present disclosure.

The following embodiments of the present disclosure are intended to embody the present disclosure, not limiting the scope of the present disclosure. What could easily be derived from the detailed description of the present disclosure and the embodiments by a person skilled in the art is interpreted as falling within the scope of the present disclosure.

The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Artificial Intelligence (AI)

Artificial intelligence is a field of studying AI or methodologies for creating AI, and machine learning is a field of defining various issues dealt with in the AI field and studying methodologies for addressing the various issues. Machine learning is defined as an algorithm that increases the performance of a certain operation through steady experiences for the operation.

An artificial neural network (ANN) is a model used in machine learning and may generically refer to a model having a problem-solving ability, which is composed of artificial neurons (nodes) forming a network via synaptic connections. The ANN may be defined by a connection pattern between neurons in different layers, a learning process for updating model parameters, and an activation function for generating an output value.

The ANN may include an input layer, an output layer, and optionally, one or more hidden layers. Each layer includes one or more neurons, and the ANN may include a synapse that links between neurons. In the ANN, each neuron may output the function value of the activation function, for the input of signals, weights, and deflections through the synapse.

Model parameters refer to parameters determined through learning and include a weight value of a synaptic connection and deflection of neurons. A hyperparameter means a parameter to be set in the machine learning algorithm before learning, and includes a learning rate, a repetition number, a mini batch size, and an initialization function.

The purpose of learning of the ANN may be to determine model parameters that minimize a loss function. The loss function may be used as an index to determine optimal model parameters in the learning process of the ANN.

Machine learning may be classified into supervised learning, unsupervised learning, and reinforcement learning according to learning methods.

Supervised learning may be a method of training an ANN in a state in which a label for training data is given, and the label may mean a correct answer (or result value) that the ANN should infer with respect to the input of training data to the ANN. Unsupervised learning may be a method of training an ANN in a state in which a label for training data is not given. Reinforcement learning may be a learning method in which an agent defined in a certain environment is trained to select a behavior or a behavior sequence that maximizes cumulative compensation in each state.

Machine learning, which is implemented by a deep neural network (DNN) including a plurality of hidden layers among ANNs, is also referred to as deep learning, and deep learning is part of machine learning. The following description is given with the appreciation that machine learning includes deep learning.

<Robot>

A robot may refer to a machine that automatically processes or executes a given task by its own capabilities. Particularly, a robot equipped with a function of recognizing an environment and performing an operation based on its decision may be referred to as an intelligent robot.

Robots may be classified into industrial robots, medical robots, consumer robots, military robots, and so on according to their usages or application fields.

A robot may be provided with a driving unit including an actuator or a motor, and thus perform various physical operations such as moving robot joints. Further, a movable robot may include a wheel, a brake, a propeller, and the like in a driving unit, and thus travel on the ground or fly in the air through the driving unit.

<Self-Driving>

Self-driving refers to autonomous driving, and a self-driving vehicle refers to a vehicle that travels with no user manipulation or minimum user manipulation.

For example, self-driving may include a technology of maintaining a lane while driving, a technology of automatically adjusting a speed, such as adaptive cruise control, a technology of automatically traveling along a predetermined route, and a technology of automatically setting a route and traveling along the route when a destination is set.

Vehicles may include a vehicle having only an internal combustion engine, a hybrid vehicle having both an internal combustion engine and an electric motor, and an electric vehicle having only an electric motor, and may include not only an automobile but also a train, a motorcycle, and the like.

Herein, a self-driving vehicle may be regarded as a robot having a self-driving function.

<eXtended Reality (XR)>

Extended reality is a generical term covering virtual reality (VR), augmented reality (AR), and mixed reality (MR). VR provides a real-world object and background only as a computer graphic (CG) image, AR provides a virtual CG image on a real object image, and MR is a computer graphic technology that mixes and combines virtual objects into the real world.

MR is similar to AR in that the real object and the virtual object are shown together. However, in AR, the virtual object is used as a complement to the real object, whereas in MR, the virtual object and the real object are handled equally.

XR may be applied to a head-mounted display (HMD), a head-up display (HUD), a portable phone, a tablet PC, a laptop computer, a desktop computer, a TV, a digital signage, and so on. A device to which XR is applied may be referred to as an XR device.

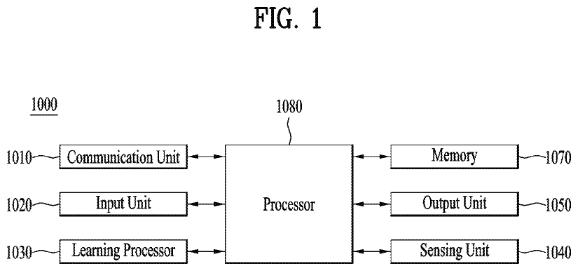

FIG. 1 is a block diagram illustrating an artificial intelligence (AI) device 1000 according to an embodiment of the present disclosure.

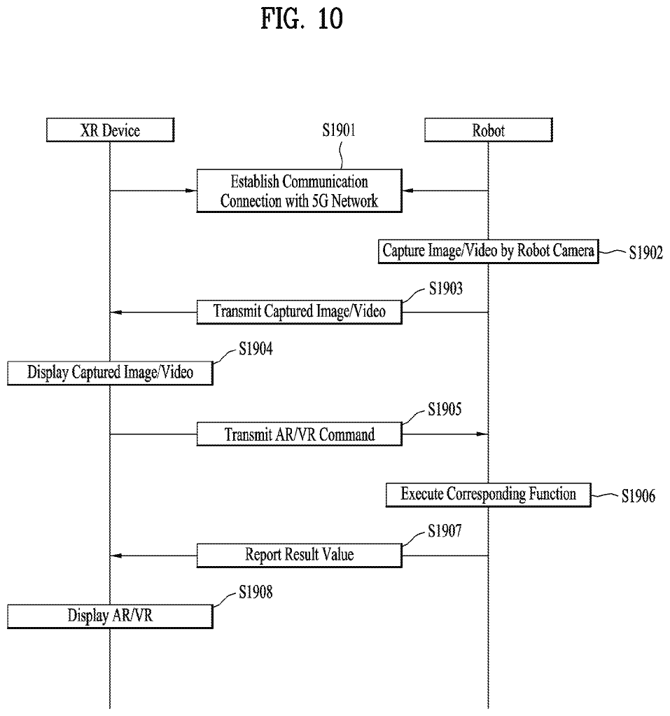

The AI device 1000 illustrated in FIG. 10 may be configured as a stationary device or a mobile device, such as a TV, a projector, a portable phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a digital multimedia broadcasting (DMB) receiver, a radio, a washing machine, a refrigerator, a digital signage, a robot, or a vehicle.

Referring to FIG. 1, the AI device 1000 may include a communication unit 1010, an input unit 1020, a learning processor 1030, a sensing unit 1040, an output unit 1050, a memory 1070, and a processor 1080.

The communication unit 1010 may transmit and receive data to and from an external device such as another AI device or an AI server by wired or wireless communication. For example, the communication unit 1010 may transmit and receive sensor information, a user input, a learning model, and a control signal to and from the external device.

Communication schemes used by the communication unit 1010 include global system for mobile communication (GSM), CDMA, LTE, 5G, wireless local area network (WLAN), wireless fidelity (Wi-Fi), Bluetooth™, radio frequency identification (RFID), infrared data association (IrDA), ZigBee, near field communication (NFC), and so on. Particularly, the 5G technology described.

The input unit 1020 may acquire various types of data. The input unit 1020 may include a camera for inputting a video signal, a microphone for receiving an audio signal, and a user input unit for receiving information from a user. The camera or the microphone may be treated as a sensor, and thus a signal acquired from the camera or the microphone may be referred to as sensing data or sensor information.

The input unit 1020 may acquire training data for model training and input data to be used to acquire an output by using a learning model. The input unit 1020 may acquire raw input data. In this case, the processor 1080 or the learning processor 1030 may extract an input feature by preprocessing the input data.

The learning processor 1030 may train a model composed of an ANN by using training data. The trained ANN may be referred to as a learning model. The learning model may be used to infer a result value for new input data, not training data, and the inferred value may be used as a basis for determination to perform a certain operation.

The learning processor 1030 may perform AI processing together with a learning processor of an AI server.

The learning processor 1030 may include a memory integrated or implemented in the AI device 1000. Alternatively, the learning processor 1030 may be implemented by using the memory 1070, an external memory directly connected to the Al device 1000, or a memory maintained in an external device.

The sensing unit 1040 may acquire at least one of internal information about the AI device 1000, ambient environment information about the AI device 1000, and user information by using various sensors.

The sensors included in the sensing unit 1040 may include a proximity sensor, an illumination sensor, an accelerator sensor, a magnetic sensor, a gyro sensor, an inertial sensor, a red, green, blue (RGB) sensor, an IR sensor, a fingerprint recognition sensor, an ultrasonic sensor, an optical sensor, a microphone, a light detection and ranging (LiDAR), and a radar.

The output unit 1050 may generate a visual, auditory, or haptic output.

Accordingly, the output unit 1050 may include a display unit for outputting visual information, a speaker for outputting auditory information, and a haptic module for outputting haptic information.

The memory 1070 may store data that supports various functions of the AI device 1000. For example, the memory 1070 may store input data acquired by the input unit 1020, training data, a learning model, a learning history, and so on.

The processor 1080 may determine at least one executable operation of the AI device 100 based on information determined or generated by a data analysis algorithm or a machine learning algorithm. The processor 1080 may control the components of the AI device 1000 to execute the determined operation.

To this end, the processor 1080 may request, search, receive, or utilize data of the learning processor 1030 or the memory 1070. The processor 1080 may control the components of the AI device 1000 to execute a predicted operation or an operation determined to be desirable among the at least one executable operation.

When the determined operation needs to be performed in conjunction with an external device, the processor 1080 may generate a control signal for controlling the external device and transmit the generated control signal to the external device.

The processor 1080 may acquire intention information with respect to a user input and determine the user's requirements based on the acquired intention information.

The processor 1080 may acquire the intention information corresponding to the user input by using at least one of a speech to text (STT) engine for converting a speech input into a text string or a natural language processing (NLP) engine for acquiring intention information of a natural language.

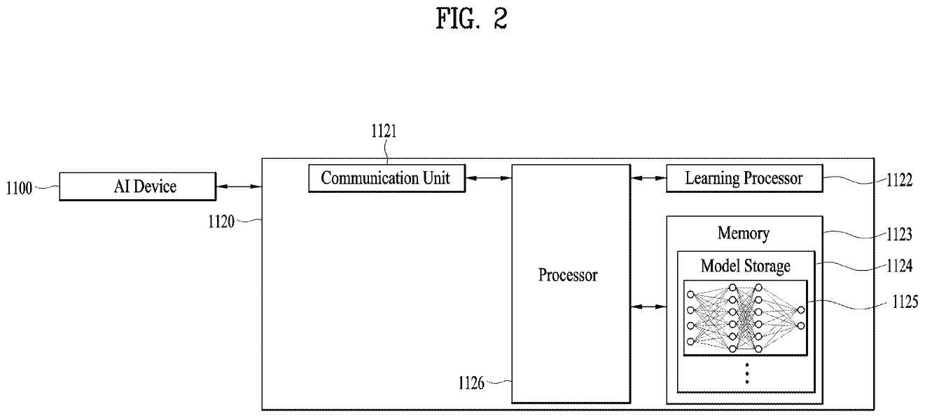

At least one of the STT engine or the NLP engine may be configured as an ANN, at least part of which is trained according to the machine learning algorithm. At least one of the STT engine or the NLP engine may be trained by the learning processor, a learning processor of the AI server, or distributed processing of the learning processors. For reference, specific components of the AI server are illustrated in FIG. 2.

The processor 1080 may collect history information including the operation contents of the AI device 1000 or the user's feedback on the operation and may store the collected history information in the memory 1070 or the learning processor 1030 or transmit the collected history information to the external device such as the AI server. The collected history information may be used to update the learning model.

The processor 1080 may control at least a part of the components of AI device 1000 so as to drive an application program stored in the memory 1070. Furthermore, the processor 1080 may operate two or more of the components included in the AI device 1000 in combination so as to drive the application program.

FIG. 2 is a block diagram illustrating an AI server 1120 according to an embodiment of the present disclosure.

Referring to FIG. 2, the AI server 1120 may refer to a device that trains an ANN by a machine learning algorithm or uses a trained ANN. The AI server 1120 may include a plurality of servers to perform distributed processing, or may be defined as a 5G network. The AI server 1120 may be included as part of the AI device 1100, and perform at least part of the AI processing.

The AI server 1120 may include a communication unit 1121, a memory 1123, a learning processor 1122, a processor 1126, and so on.

The communication unit 1121 may transmit and receive data to and from an external device such as the AI device 1100.

The memory 1123 may include a model storage 1124. The model storage 1124 may store a model (or an ANN 1125) which has been trained or is being trained through the learning processor 1122.

The learning processor 1122 may train the ANN 1125 by training data. The learning model may be used, while being loaded on the AI server 1120 of the ANN, or on an external device such as the AI device 1110.

The learning model may be implemented in hardware, software, or a combination of hardware and software. If all or part of the learning model is implemented in software, one or more instructions of the learning model may be stored in the memory 1123.

The processor 1126 may infer a result value for new input data by using the learning model and may generate a response or a control command based on the inferred result value.

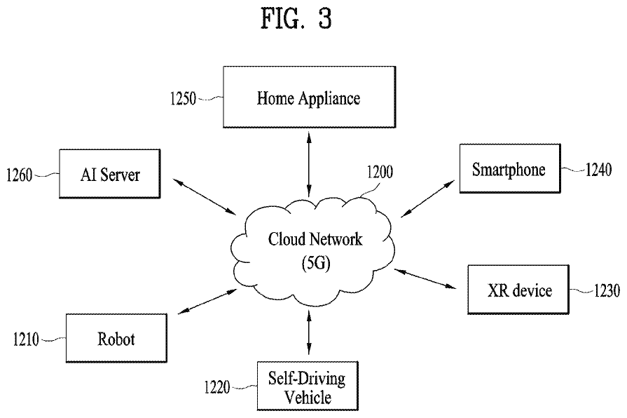

FIG. 3 is a diagram illustrating an AI system according to an embodiment of the present disclosure.

Referring to FIG. 3, in the AI system, at least one of an AI server 1260, a robot 1210, a self-driving vehicle 1220, an XR device 1230, a smartphone 1240, or a home appliance 1250 is connected to a cloud network 1200. The robot 1210, the self-driving vehicle 1220, the XR device 1230, the smartphone 1240, or the home appliance 1250, to which AI is applied, may be referred to as an AI device.

The cloud network 1200 may refer to a network that forms part of cloud computing infrastructure or exists in the cloud computing infrastructure. The cloud network 1200 may be configured by using a 3G network, a 4G or LTE network, or a 5G network.

That is, the devices 1210 to 1260 included in the AI system may be interconnected via the cloud network 1200. In particular, each of the devices 1210 to 1260 may communicate with each other directly or through a BS.

The AI server 1260 may include a server that performs AI processing and a server that performs computation on big data.

The AI server 1260 may be connected to at least one of the AI devices included in the AI system, that is, at least one of the robot 1210, the self-driving vehicle 1220, the XR device 1230, the smartphone 1240, or the home appliance 1250 via the cloud network 1200, and may assist at least part of AI processing of the connected AI devices 1210 to 1250.

The AI server 1260 may train the ANN according to the machine learning algorithm on behalf of the AI devices 1210 to 1250, and may directly store the learning model or transmit the learning model to the AI devices 1210 to 1250.

The AI server 1260 may receive input data from the AI devices 1210 to 1250, infer a result value for received input data by using the learning model, generate a response or a control command based on the inferred result value, and transmit the response or the control command to the AI devices 1210 to 1250.

Alternatively, the AI devices 1210 to 1250 may infer the result value for the input data by directly using the learning model, and generate the response or the control command based on the inference result.

Hereinafter, various embodiments of the AI devices 1210 to 1250 to which the above-described technology is applied will be described. The AI devices 1210 to 1250 illustrated in FIG. 3 may be regarded as a specific embodiment of the AI device 1000 illustrated in FIG. 1.

<AI+XR>

The XR device 1230, to which AI is applied, may be configured as a HMD, a HUD provided in a vehicle, a TV, a portable phone, a smartphone, a computer, a wearable device, a home appliance, a digital signage, a vehicle, a fixed robot, a mobile robot, or the like.

The XR device 1230 may acquire information about a surrounding space or a real object by analyzing 3D point cloud data or image data acquired from various sensors or an external device and thus generating position data and attribute data for the 3D points, and may render an XR object to be output. For example, the XR device 1230 may output an XR object including additional information about a recognized object in correspondence with the recognized object.

The XR device 1230 may perform the above-described operations by using the learning model composed of at least one ANN. For example, the XR device 1230 may recognize a real object from 3D point cloud data or image data by using the learning model, and may provide information corresponding to the recognized real object. The learning model may be trained directly by the XR device 1230 or by the external device such as the AI server 1260.

While the XR device 1230 may operate by generating a result by directly using the learning model, the XR device 1230 may operate by transmitting sensor information to the external device such as the AI server 1260 and receiving the result.

<AI+Robot+XR>

The robot 1210, to which AI and XR are applied, may be implemented as a guide robot, a delivery robot, a cleaning robot, a wearable robot, an entertainment robot, a pet robot, an unmanned flying robot, a drone, or the like.

The robot 1210, to which XR is applied, may refer to a robot to be controlled/interact within an XR image. In this case, the robot 1210 may be distinguished from the XR device 1230 and interwork with the XR device 1230.

When the robot 1210 to be controlled/interact within an XR image acquires sensor information from sensors each including a camera, the robot 1210 or the XR device 1230 may generate an XR image based on the sensor information, and the XR device 1230 may output the generated XR image. The robot 1210 may operate based on the control signal received through the XR device 1230 or based on the user's interaction.

For example, the user may check an XR image corresponding to a view of the robot 1210 interworking remotely through an external device such as the XR device 1210, adjust a self-driving route of the robot 1210 through interaction, control the operation or driving of the robot 1210, or check information about an ambient object around the robot 1210.

<AI+Self-Driving+XR>

The self-driving vehicle 1220, to which AI and XR are applied, may be implemented as a mobile robot, a vehicle, an unmanned flying vehicle, or the like.

The self-driving driving vehicle 1220, to which XR is applied, may refer to a self-driving vehicle provided with a means for providing an XR image or a self-driving vehicle to be controlled/interact within an XR image. Particularly, the self-driving vehicle 1220 to be controlled/interact within an XR image may be distinguished from the XR device 1230 and interwork with the XR device 1230.

The self-driving vehicle 1220 provided with the means for providing an XR image may acquire sensor information from the sensors each including a camera and output the generated XR image based on the acquired sensor information. For example, the self-driving vehicle 1220 may include an HUD to output an XR image, thereby providing a passenger with an XR object corresponding to a real object or an object on the screen.

When the XR object is output to the HUD, at least part of the XR object may be output to be overlaid on an actual object to which the passenger's gaze is directed. When the XR object is output to a display provided in the self-driving vehicle 1220, at least part of the XR object may be output to be overlaid on the object within the screen. For example, the self-driving vehicle 1220 may output XR objects corresponding to objects such as a lane, another vehicle, a traffic light, a traffic sign, a two-wheeled vehicle, a pedestrian, a building, and so on.

When the self-driving vehicle 1220 to be controlled/interact within an XR image acquires sensor information from the sensors each including a camera, the self-driving vehicle 1220 or the XR device 1230 may generate the XR image based on the sensor information, and the XR device 1230 may output the generated XR image. The self-driving vehicle 1220 may operate based on a control signal received through an external device such as the XR device 1230 or based on the user's interaction.

VR, AR, and MR technologies of the present disclosure are applicable to various devices, particularly, for example, a HMD, a HUD attached to a vehicle, a portable phone, a tablet PC, a laptop computer, a desktop computer, a TV, and a signage. The VR, AR, and MR technologies may also be applicable to a device equipped with a flexible or rollable display.

The above-described VR, AR, and MR technologies may be implemented based on CG and distinguished by the ratios of a CG image in an image viewed by the user.

That is, VR provides a real object or background only in a CG image, whereas AR overlays a virtual CG image on an image of a real object.

MR is similar to AR in that virtual objects are mixed and combined with a real world. However, a real object and a virtual object created as a CG image are distinctive from each other and the virtual object is used to complement the real object in AR, whereas a virtual object and a real object are handled equally in MR. More specifically, for example, a hologram service is an MR representation.

These days, VR, AR, and MR are collectively called XR without distinction among them. Therefore, embodiments of the present disclosure are applicable to all of VR, AR, MR, and XR.

For example, wired/wireless communication, input interfacing, output interfacing, and computing devices are available as hardware (HW)-related element techniques applied to VR, AR, MR, and XR. Further, tracking and matching, speech recognition, interaction and user interfacing, location-based service, search, and AI are available as software (SW)-related element techniques.

Particularly, the embodiments of the present disclosure are intended to address at least one of the issues of communication with another device, efficient memory use, data throughput decrease caused by inconvenient user experience/user interface (UX/UI), video, sound, motion sickness, or other issues.

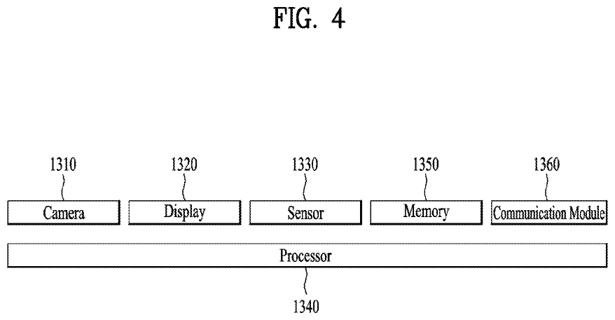

FIG. 4 is a block diagram illustrating an extended reality (XR) device according to embodiments of the present disclosure. The XR device 1300 includes a camera 1310, a display 1320, a sensor 1330, a processor 1340, a memory 1350, and a communication module 1360. Obviously, one or more of the modules may be deleted or modified, and one or more modules may be added to the modules, when needed, without departing from the scope and spirit of the present disclosure.

The communication module 1360 may communicate with an external device or a server, wiredly or wirelessly. The communication module 1360 may use, for example, Wi-Fi, Bluetooth, or the like, for short-range wireless communication, and for example, a 3GPP communication standard for long-range wireless communication. LTE is a technology beyond 3GPP TS 36.xxx Release 8. Specifically, LTE beyond 3GPP TS 36.xxx Release 10 is referred to as LTE-A, and LTE beyond 3GPP TS 36.xxx Release 13 is referred to as LTE-A pro. 3GPP 5G refers to a technology beyond TS 36.xxx Release 15 and a technology beyond TS 38.XXX Release 15. Specifically, the technology beyond TS 38.xxx Release 15 is referred to as 3GPP NR, and the technology beyond TS 36.xxx Release 15 is referred to as enhanced LTE. “xxx” represents the number of a technical specification. LTE/NR may be collectively referred to as a 3GPP system.

The camera 1310 may capture an ambient environment of the XR device 1300 and convert the captured image to an electric signal. The image, which has been captured and converted to an electric signal by the camera 1310, may be stored in the memory 1350 and then displayed on the display 1320 through the processor 1340. Further, the image may be displayed on the display 1320 by the processor 1340, without being stored in the memory 1350. Further, the camera 110 may have a field of view (FoV). The FoV is, for example, an area in which a real object around the camera 1310 may be detected. The camera 1310 may detect only a real object within the FoV. When a real object is located within the FoV of the camera 1310, the XR device 1300 may display an AR object corresponding to the real object. Further, the camera 1310 may detect an angle between the camera 1310 and the real object.

The sensor 1330 may include at least one sensor. For example, the sensor 1330 includes a sensing means such as a gravity sensor, a geomagnetic sensor, a motion sensor, a gyro sensor, an accelerator sensor, an inclination sensor, a brightness sensor, an altitude sensor, an olfactory sensor, a temperature sensor, a depth sensor, a pressure sensor, a bending sensor, an audio sensor, a video sensor, a global positioning system (GPS) sensor, and a touch sensor. Further, although the display 1320 may be of a fixed type, the display 1320 may be configured as a liquid crystal display (LCD), an organic light emitting diode (OLED) display, an electroluminescent display (ELD), or a micro LED (M-LED) display, to have flexibility. Herein, the sensor 1330 is designed to detect a bending degree of the display 1320 configured as the afore-described LCD, OLED display, ELD, or M-LED display.

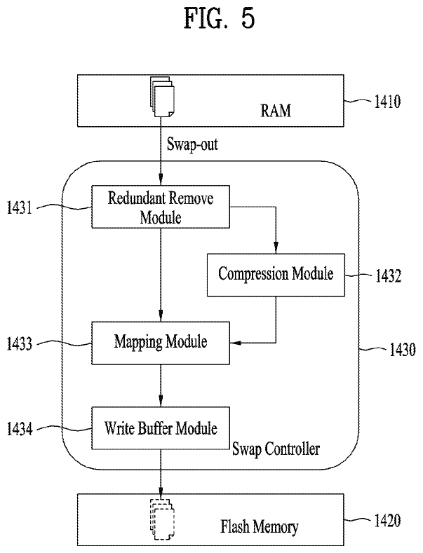

The memory 1350 is equipped with a function of storing all or a part of result values obtained by wired/wireless communication with an external device or a service as well as a function of storing an image captured by the camera 1310. Particularly, considering the trend toward increased communication data traffic (e.g., in a 5G communication environment), efficient memory management is required. In this regard, a description will be given below with reference to FIG. 5.

FIG. 5 is a detailed block diagram illustrating a memory illustrated in FIG. 4. With reference to FIG. 5, a swap-out process between a random access memory (RAM) and a flash memory according to an embodiment of the present disclosure will be described.

When swapping out AR/VR page data from a RAM 1410 to a flash memory 1420, a controller 1430 may swap out only one of two or more AR/VR page data of the same contents among AR/VR page data to be swapped out to the flash memory 1420.

That is, the controller 1430 may calculate an identifier (e.g., a hash function) that identifies each of the contents of the AR/VR page data to be swapped out, and determine that two or more AR/VR page data having the same identifier among the calculated identifiers contain the same contents. Accordingly, the problem that the lifetime of an AR/VR device including the flash memory 1420 as well as the lifetime of the flash memory 1420 is reduced because unnecessary AR/VR page data is stored in the flash memory 1420 may be overcome.

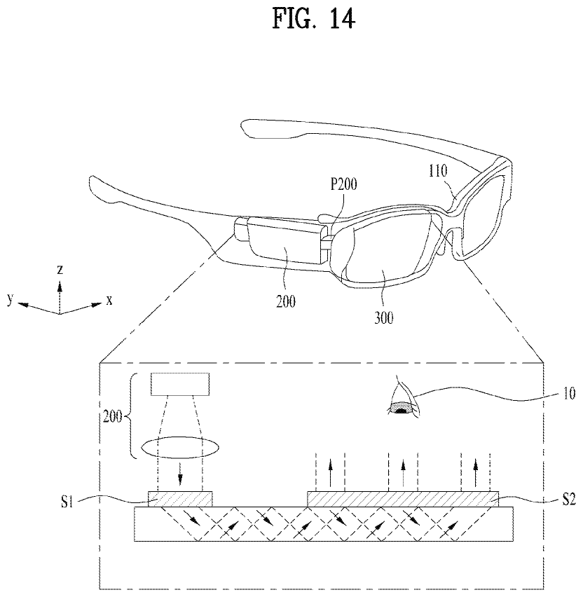

The operations of the controller 1430 may be implemented in software or hardware without departing from the scope of the present disclosure. More specifically, the memory illustrated in FIG. 14 is included in a HMD, a vehicle, a portable phone, a tablet PC, a laptop computer, a desktop computer, a TV, a signage, or the like, and executes a swap function.

A device according to embodiments of the present disclosure may process 3D point cloud data to provide various services such as VR, AR, MR, XR, and self-driving to a user.

A sensor collecting 3D point cloud data may be any of, for example, a LiDAR, a red, green, blue depth (RGB-D), and a 3D laser scanner. The sensor may be mounted inside or outside of a HMD, a vehicle, a portable phone, a tablet PC, a laptop computer, a desktop computer, a TV, a signage, or the like.

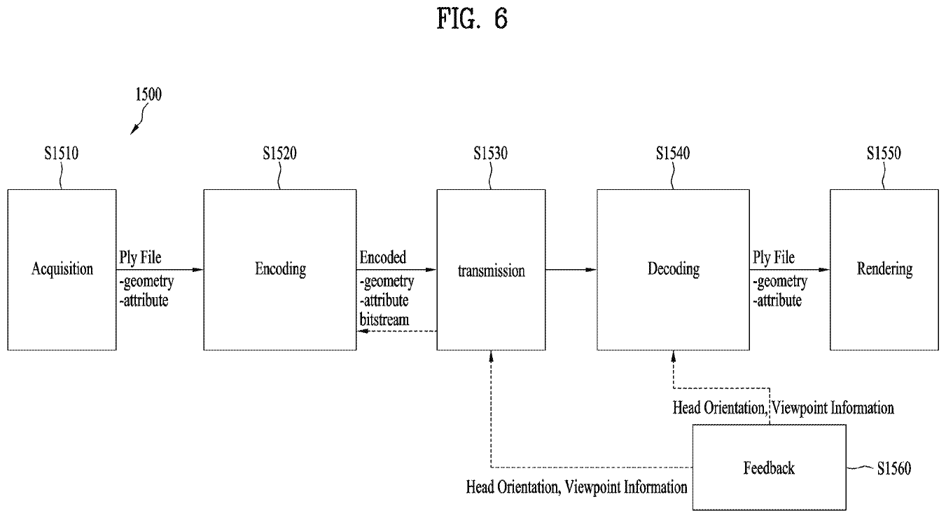

FIG. 6 is a block diagram illustrating a point cloud data processing system.

Referring to FIG. 6, a point cloud processing system 1500 includes a transmission device which acquires, encodes, and transmits point cloud data, and a reception device which acquires point cloud data by receiving and decoding video data. As illustrated in FIG. 6, point cloud data according to embodiments of the present disclosure may be acquired by capturing, synthesizing, or generating the point cloud data (S1510). During the acquisition, data (e.g., a polygon file format or standard triangle format (PLY) file) of 3D positions (x, y, z)/attributes (color, reflectance, transparency, and so on) of points may be generated. For a video of multiple frames, one or more files may be acquired. Point cloud data-related metadata (e.g., metadata related to capturing) may be generated during the capturing. The transmission device or encoder according to embodiments of the present disclosure may encode the point cloud data by video-based point cloud compression (V-PCC) or geometry-based point cloud compression (G-PCC), and output one or more video streams (S1520). V-PCC is a scheme of compressing point cloud data based on a 2D video codec such as high efficiency video coding (HEVC) or versatile video coding (VVC), G-PCC is a scheme of encoding point cloud data separately into two streams: geometry and attribute. The geometry stream may be generated by reconstructing and encoding position information about points, and the attribute stream may be generated by reconstructing and encoding attribute information (e.g., color) related to each point. In V-PCC, despite compatibility with a 2D video, much data is required to recover V-PCC-processed data (e.g., geometry video, attribute video, occupancy map video, and auxiliary information), compared to G-PCC, thereby causing a long latency in providing a service. One or more output bit streams may be encapsulated along with related metadata in the form of a file (e.g., a file format such as ISOBMFF) and transmitted over a network or through a digital storage medium (S1530).

The device or processor according to embodiments of the present disclosure may acquire one or more bit streams and related metadata by decapsulating the received video data, and recover 3D point cloud data by decoding the acquired bit streams in V-PCC or G-PCC (S1540). A renderer may render the decoded point cloud data and provide content suitable for VR/AR/MR/service to the user on a display (S1550).

As illustrated in FIG. 6, the device or processor according to embodiments of the present disclosure may perform a feedback process of transmitting various pieces of feedback information acquired during the rendering/display to the transmission device or to the decoding process (S1560). The feedback information according to embodiments of the present disclosure may include head orientation information, viewport information indicating an area that the user is viewing, and so on. Because the user interacts with a service (or content) provider through the feedback process, the device according to embodiments of the present disclosure may provide a higher data processing speed by using the afore-described V-PCC or G-PCC scheme or may enable clear video construction as well as provide various services in consideration of high user convenience.

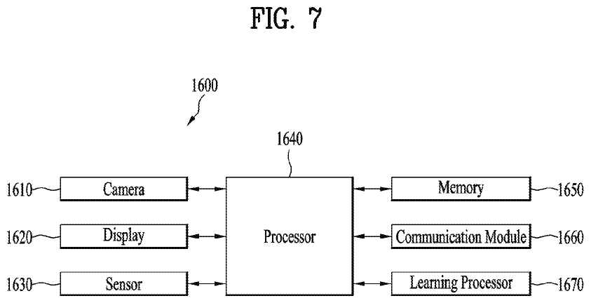

FIG. 7 is a block diagram illustrating an XR device 1600 including a learning processor. Compared to FIG. 4, only a learning processor 1670 is added, and thus a redundant description is avoided because FIG. 4 may be referred to for the other components.

Referring to FIG. 7, the XR device 1600 may be loaded with a learning model. The learning model may be implemented in hardware, software, or a combination of hardware and software. If the whole or part of the learning model is implemented in software, one or more instructions that form the learning model may be stored in a memory 1650.

According to embodiments of the present disclosure, a learning processor 1670 may be coupled communicably to a processor 1640, and repeatedly train a model including ANNs by using training data. An ANN is an information processing system in which multiple neurons are linked in layers, modeling an operation principle of biological neurons and links between neurons. An ANN is a statistical learning algorithm inspired by a neural network (particularly the brain in the central nervous system of an animal) in machine learning and cognitive science. Machine learning is one field of AI, in which the ability of learning without an explicit program is granted to a computer. Machine learning is a technology of studying and constructing a system for learning, predicting, and improving its capability based on empirical data, and an algorithm for the system. Therefore, according to embodiments of the present disclosure, the learning processor 1670 may infer a result value from new input data by determining optimized model parameters of an ANN. Therefore, the learning processor 1670 may analyze a device use pattern of a user based on device use history information about the user. Further, the learning processor 1670 may be configured to receive, classify, store, and output information to be used for data mining, data analysis, intelligent decision, and a machine learning algorithm and technique.

According to embodiments of the present disclosure, the processor 1640 may determine or predict at least one executable operation of the device based on data analyzed or generated by the learning processor 1670. Further, the processor 1640 may request, search, receive, or use data of the learning processor 1670, and control the XR device 1600 to perform a predicted operation or an operation determined to be desirable among the at least one executable operation. According to embodiments of the present disclosure, the processor 1640 may execute various functions of realizing intelligent emulation (i.e., knowledge-based system, reasoning system, and knowledge acquisition system). The various functions may be applied to an adaptation system, a machine learning system, and various types of systems including an ANN (e.g., a fuzzy logic system). That is, the processor 1640 may predict a user's device use pattern based on data of a use pattern analyzed by the learning processor 1670, and control the XR device 1600 to provide a more suitable XR service to the UE. Herein, the XR service includes at least one of the AR service, the VR service, or the MR service.

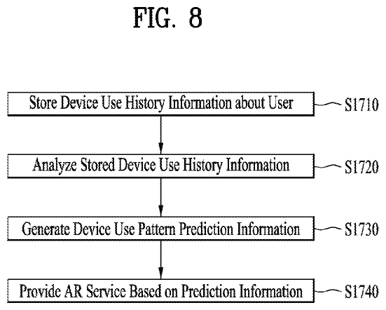

FIG. 8 is a flowchart illustrating a process of providing an XR service by an XR device 1600 of the present disclosure, illustrated in FIG. 7.

According to embodiments of the present disclosure, the processor 1670 may store device use history information about a user in the memory 1650 (S1710). The device use history information may include information about the name, category, and contents of content provided to the user, information about a time at which a device has been used, information about a place in which the device has been used, time information, and information about use of an application installed in the device.

According to embodiments of the present disclosure, the learning processor 1670 may acquire device use pattern information about the user by analyzing the device use history information (S1720). For example, when the XR device 1600 provides specific content A to the user, the learning processor 1670 may learn information about a pattern of the device used by the user using the corresponding terminal by combining specific information about content A (e.g., information about the ages of users that generally use content A, information about the contents of content A, and content information similar to content A), and information about the time points, places, and number of times in which the user using the corresponding terminal has consumed content A.

According to embodiments of the present disclosure, the processor 1640 may acquire the user device pattern information generated based on the information learned by the learning processor 1670, and generate device use pattern prediction information (S1730). Further, when the user is not using the device 1600, if the processor 1640 determines that the user is located in a place where the user has frequently used the device 1600, or it is almost time for the user to usually use the device 1600, the processor 1640 may indicate the device 1600 to operate. In this case, the device according to embodiments of the present disclosure may provide AR content based on the user pattern prediction information (S1740).

When the user is using the device 1600, the processor 1640 may check information about content currently provided to the user, and generate device use pattern prediction information about the user in relation to the content (e.g., when the user requests other related content or additional data related to the current content). Further, the processor 1640 may provide AR content based on the device use pattern prediction information by indicating the device 1600 to operate (S1740). The AR content according to embodiments of the present disclosure may include an advertisement, navigation information, danger information, and so on.

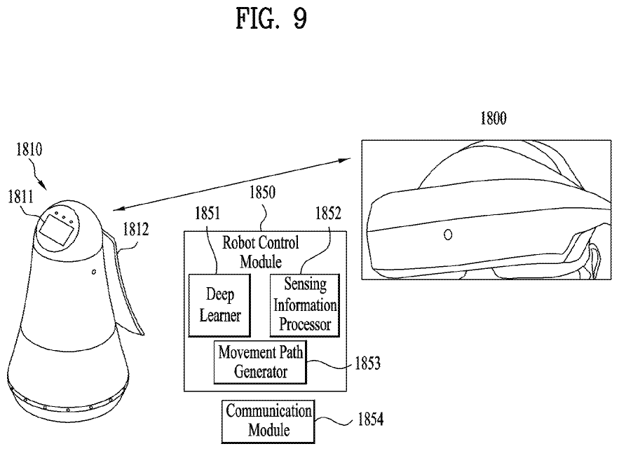

FIG. 9 is a diagram illustrating the outer appearances of an XR device and a robot.

Component modules of an XR device 1800 according to an embodiment of the present disclosure have been described before with reference to the previous drawings, and thus a redundant description is not provided herein.

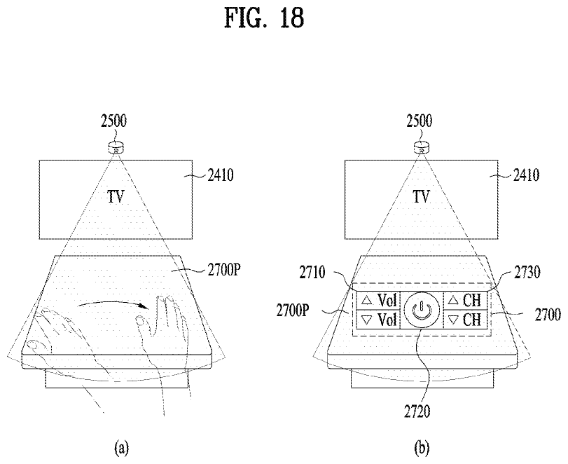

The outer appearance of a robot 1810 illustrated in FIG. 9 is merely an example, and the robot 1810 may be implemented to have various outer appearances according to the present disclosure. For example, the robot 1810 illustrated in FIG. 18 may be a drone, a cleaner, a cook root, a wearable robot, or the like. Particularly, each component of the robot 1810 may be disposed at a different position such as up, down, left, right, back, or forth according to the shape of the robot 1810.

The robot 1810 may be provided, on the exterior thereof, with various sensors to identify ambient objects. Further, to provide specific information to a user, the robot 1810 may be provided with an interface unit 1811 on top or the rear surface 1812 thereof.

To sense movement of the robot 1810 and an ambient object, and control the robot 1810, a robot control module 1850 is mounted inside the robot 1810. The robot control module 1850 may be implemented as a software module or a hardware chip with the software module implemented therein. The robot control module 1850 may include a deep learner 1851, a sensing information processor 1852, a movement path generator 1853, and a communication module 1854.

The sensing information processor 1852 collects and processes information sensed by various types of sensors (e.g., a LiDAR sensor, an IR sensor, an ultrasonic sensor, a depth sensor, an image sensor, and a microphone) arranged in the robot 1810.

The deep learner 1851 may receive information processed by the sensing information processor 1851 or accumulative information stored during movement of the robot 1810, and output a result required for the robot 1810 to determine an ambient situation, process information, or generate a moving path.

The moving path generator 1852 may calculate a moving path of the robot 1810 by using the data calculated by the deep learner 8151 or the data processed by the sensing information processor 1852.

Because each of the XR device 1800 and the robot 1810 is provided with a communication module, the XR device 1800 and the robot 1810 may transmit and receive data by short-range wireless communication such as Wi-Fi or Bluetooth, or 5G long-range wireless communication. A technique of controlling the robot 1810 by using the XR device 1800 will be described below with reference to FIG. 10.

FIG. 10 is a flowchart illustrating a process of controlling a robot by using an XR device.

The XR device and the robot are connected communicably to a 5G network (S1901). Obviously, the XR device and the robot may transmit and receive data by any other short-range or long-range communication technology without departing from the scope of the present disclosure.

The robot captures an image/video of the surroundings of the robot by means of at least one camera installed on the interior or exterior of the robot (S1902) and transmits the captured image/video to the XR device (S1903). The XR device displays the captured image/video (S1904) and transmits a command for controlling the robot to the robot (S1905). The command may be input manually by a user of the XR device or automatically generated by AI without departing from the scope of the disclosure.

The robot executes a function corresponding to the command received in step S1905 (S1906) and transmits a result value to the XR device (S1907). The result value may be a general indicator indicating whether data has been successfully processed or not, a current captured image, or specific data in which the XR device is considered. The specific data is designed to change, for example, according to the state of the XR device. If a display of the XR device is in an off state, a command for turning on the display of the XR device is included in the result value in step S1907. Therefore, when an emergency situation occurs around the robot, even though the display of the remote XR device is turned off, a notification message may be transmitted.

AR/VR content is displayed according to the result value received in step S1907 (S1908).

According to another embodiment of the present disclosure, the XR device may display position information about the robot by using a GPS module attached to the robot.

The XR device 1300 described with reference to FIG. 4 may be connected to a vehicle that provides a self-driving service in a manner that allows wired/wireless communication, or may be mounted on the vehicle that provides the self-driving service. Accordingly, various services including AR/VR may be provided even in the vehicle that provides the self-driving service.

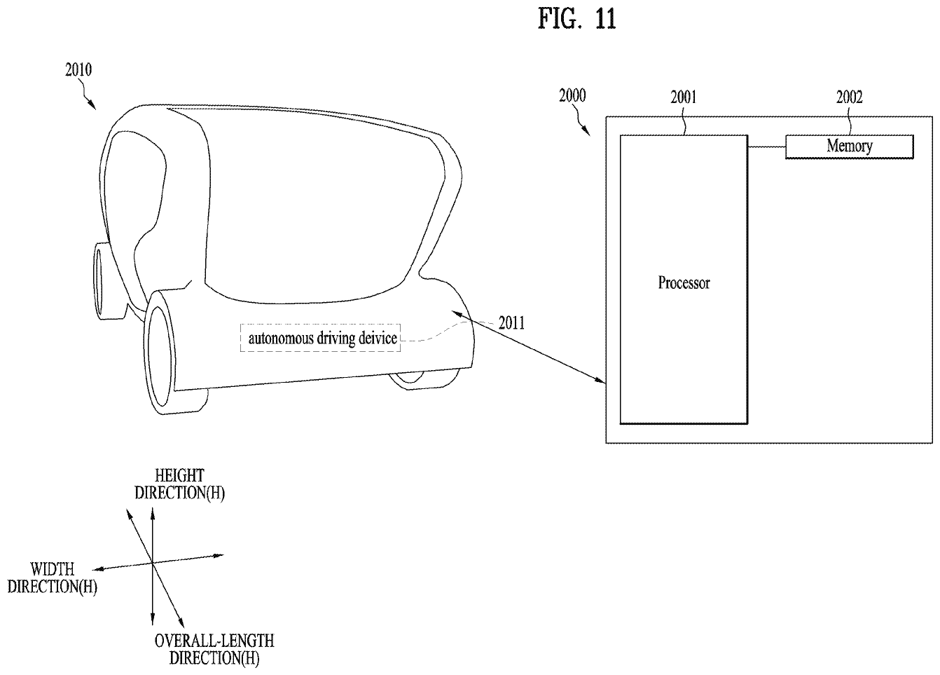

FIG. 11 is a diagram illustrating a vehicle that provides a self-driving service.

According to embodiments of the present disclosure, a vehicle 2010 may include a car, a train, and a motor bike as transportation means traveling on a road or a railway. According to embodiments of the present disclosure, the vehicle 2010 may include all of an internal combustion engine vehicle provided with an engine as a power source, a hybrid vehicle provided with an engine and an electric motor as a power source, and an electric vehicle provided with an electric motor as a power source.

According to embodiments of the present disclosure, the vehicle 2010 may include the following components in order to control operations of the vehicle 2010: a user interface device, an object detection device, a communication device, a driving maneuver device, a main electronic control unit (ECU), a drive control device, a self-driving device, a sensing unit, and a position data generation device.

Each of the user interface device, the object detection device, the communication device, the driving maneuver device, the main ECU, the drive control device, the self-driving device, the sensing unit, and the position data generation device may generate an electric signal, and be implemented as an electronic device that exchanges electric signals.

The user interface device may receive a user input and provide information generated from the vehicle 2010 to a user in the form of a UI or UX. The user interface device may include an input/output (I/O) device and a user monitoring device. The object detection device may detect the presence or absence of an object outside of the vehicle 2010, and generate information about the object. The object detection device may include at least one of, for example, a camera, a LiDAR, an IR sensor, or an ultrasonic sensor. The camera may generate information about an object outside of the vehicle 2010. The camera may include one or more lenses, one or more image sensors, and one or more processors for generating object information. The camera may acquire information about the position, distance, or relative speed of an object by various image processing algorithms. Further, the camera may be mounted at a position where the camera may secure an FoV in the vehicle 2010, to capture an image of the surroundings of the vehicle 1020, and may be used to provide an AR/VR-based service. The LiDAR may generate information about an object outside of the vehicle 2010. The LiDAR may include a light transmitter, a light receiver, and at least one processor which is electrically coupled to the light transmitter and the light receiver, processes a received signal, and generates data about an object based on the processed signal.

The communication device may exchange signals with a device (e.g., infrastructure such as a server or a broadcasting station), another vehicle, or a terminal) outside of the vehicle 2010. The driving maneuver device is a device that receives a user input for driving. In manual mode, the vehicle 2010 may travel based on a signal provided by the driving maneuver device. The driving maneuver device may include a steering input device (e.g., a steering wheel), an acceleration input device (e.g., an accelerator pedal), and a brake input device (e.g., a brake pedal).

The sensing unit may sense a state of the vehicle 2010 and generate state information. The position data generation device may generate position data of the vehicle 2010. The position data generation device may include at least one of a GPS or a differential global positioning system (DGPS). The position data generation device may generate position data of the vehicle 2010 based on a signal generated from at least one of the GPS or the DGPS. The main ECU may provide overall control to at least one electronic device provided in the vehicle 2010, and the drive control device may electrically control a vehicle drive device in the vehicle 2010.

The self-driving device may generate a path for the self-driving service based on data acquired from the object detection device, the sensing unit, the position data generation device, and so on. The self-driving device may generate a driving plan for driving along the generated path, and generate a signal for controlling movement of the vehicle according to the driving plan. The signal generated from the self-driving device is transmitted to the drive control device, and thus the drive control device may control the vehicle drive device in the vehicle 2010.

As illustrated in FIG. 11, the vehicle 2010 that provides the self-driving service is connected to an XR device 2000 in a manner that allows wired/wireless communication. The XR device 2000 may include a processor 2001 and a memory 2002. While not shown, the XR device 2000 of FIG. 11 may further include the components of the XR device 1300 described before with reference to FIG. 4.

If the XR device 2000 is connected to the vehicle 2010 in a manner that allows wired/wireless communication. The XR device 2000 may receive/process AR/VR service-related content data that may be provided along with the self-driving service, and transmit the received/processed AR/VR service-related content data to the vehicle 2010. Further, when the XR device 2000 is mounted on the vehicle 2010, the XR device 2000 may receive/process AR/VR service-related content data according to a user input signal received through the user interface device and provide the received/processed AR/VR service-related content data to the user. In this case, the processor 2001 may receive/process the AR/VR service-related content data based on data acquired from the object detection device, the sensing unit, the position data generation device, the self-driving device, and so on. According to embodiments of the present disclosure, the AR/VR service-related content data may include entertainment content, weather information, and so on which are not related to the self-driving service as well as information related to the self-driving service such as driving information, path information for the self-driving service, driving maneuver information, vehicle state information, and object information.

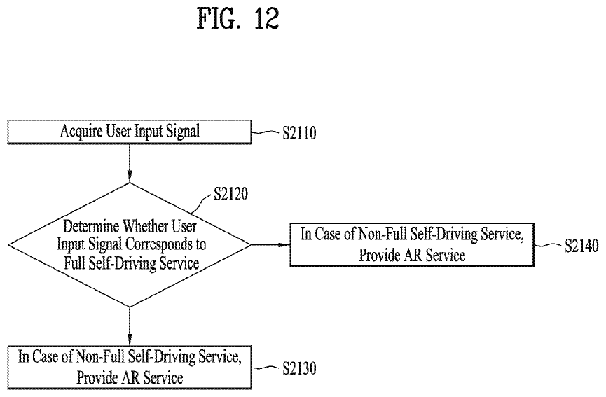

FIG. 12 is a flowchart illustrating a process of providing an augmented reality/virtual reality (AR/VR) service during a self-driving service in progress.

According to embodiments of the present disclosure, a vehicle or a user interface device may receive a user input signal (S2110). According to embodiments of the present disclosure, the user input signal may include a signal indicating a self-driving service. According to embodiments of the present disclosure, the self-driving service may include a full self-driving service and a general self-driving service. The full self-driving service refers to perfect self-driving of a vehicle to a destination without a user's manual driving, whereas the general self-driving service refers to driving a vehicle to a destination through a user's manual driving and self-driving in combination.

It may be determined whether the user input signal according to embodiments of the present disclosure corresponds to the full self-driving service (S2120). When it is determined that the user input signal corresponds to the full self-driving service, the vehicle according to embodiments of the present disclosure may provide the full self-driving service (S2130). Because the full self-driving service does not need the user's manipulation, the vehicle according to embodiments of the present disclosure may provide VR service-related content to the user through a window of the vehicle, a side mirror of the vehicle, an HMD, or a smartphone (S2130). The VR service-related content according to embodiments of the present disclosure may be content related to full self-driving (e.g., navigation information, driving information, and external object information), and may also be content which is not related to full self-driving according to user selection (e.g., weather information, a distance image, a nature image, and a voice call image).

If it is determined that the user input signal does not correspond to the full self-driving service, the vehicle according to embodiments of the present disclosure may provide the general self-driving service (S2140). Because the FoV of the user should be secured for the user's manual driving in the general self-driving service, the vehicle according to embodiments of the present disclosure may provide AR service-related content to the user through a window of the vehicle, a side mirror of the vehicle, an HMD, or a smartphone (S2140).

The AR service-related content according to embodiments of the present disclosure may be content related to full self-driving (e.g., navigation information, driving information, and external object information), and may also be content which is not related to self-driving according to user selection (e.g., weather information, a distance image, a nature image, and a voice call image).

While the present disclosure is applicable to all the fields of 5G communication, robot, self-driving, and AI as described before, the following description will be given mainly of the present disclosure applicable to an XR device with reference to following figures.

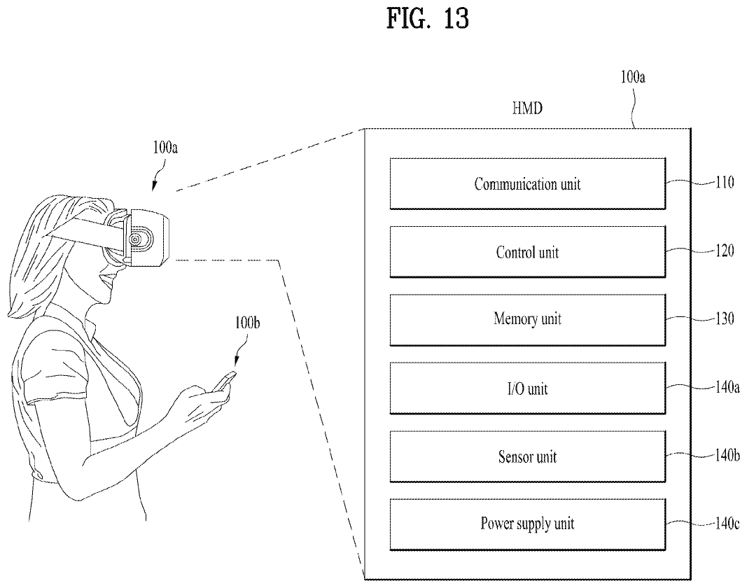

FIG. 13 is a conceptual diagram illustrating an exemplary method for implementing an XR device using an HMD type according to an embodiment of the present disclosure. The above-mentioned embodiments may also be implemented in HMD types shown in FIG. 13.

The HMD-type XR device 100a shown in FIG. 13 may include a communication unit 110, a control unit 120, a memory unit 130, an input/output (I/O) unit 140a, a sensor unit 140b, a power-supply unit 140c, etc. Specifically, the communication unit 110 embedded in the XR device 10a may communicate with a mobile terminal 100b by wire or wirelessly.

FIG. 14 is a conceptual diagram illustrating an exemplary method for implementing an XR device using AR glasses according to an embodiment of the present disclosure. The above-mentioned embodiments may also be implemented in AR glass types shown in FIG. 14.

Referring to FIG. 14, the AR glasses may include a frame, a control unit 200, and an optical display unit 300.

Although the frame may be formed in a shape of glasses worn on the face of the user 10 as shown in FIG. 14, the scope or spirit of the present disclosure is not limited thereto, and it should be noted that the frame may also be formed in a shape of goggles worn in close contact with the face of the user 10.

The frame may include a front frame 110 and first and second side frames.

The front frame 110 may include at least one opening, and may extend in a first horizontal direction (i.e., an X-axis direction). The first and second side frames may extend in the second horizontal direction (i.e., a Y-axis direction) perpendicular to the front frame 110, and may extend in parallel to each other.

The control unit 200 may generate an image to be viewed by the user 10 or may generate the resultant image formed by successive images. The control unit 200 may include an image source configured to create and generate images, a plurality of lenses configured to diffuse and converge light generated from the image source, and the like. The images generated by the control unit 200 may be transferred to the optical display unit 300 through a guide lens P200 disposed between the control unit 200 and the optical display unit 300.

The controller 200 may be fixed to any one of the first and second side frames. For example, the control unit 200 may be fixed to the inside or outside of any one of the side frames, or may be embedded in and integrated with any one of the side frames.

The optical display unit 300 may be formed of a translucent material, so that the optical display unit 300 can display images created by the control unit 200 for recognition of the user 10 and can allow the user to view the external environment through the opening.

The optical display unit 300 may be inserted into and fixed to the opening contained in the front frame 110, or may be located at the rear surface (interposed between the opening and the user 10) of the opening so that the optical display unit 300 may be fixed to the front frame 110. For example, the optical display unit 300 may be located at the rear surface of the opening, and may be fixed to the front frame 110 as an example.

Referring to the XR device shown in FIG. 14, when images are incident upon an incident region S1 of the optical display unit 300 by the control unit 200, image light may be transmitted to an emission region S2 of the optical display unit 300 through the optical display unit 300, images created by the controller 200 can be displayed for recognition of the user 10.

Accordingly, the user 10 may view the external environment through the opening of the frame 100, and at the same time may view the images created by the control unit 200.

As described above, although the present disclosure can be applied to all the 5G communication technology, robot technology, autonomous driving technology, and

Artificial Intelligence (AI) technology, following figures illustrate various examples of the present disclosure applicable to multimedia devices such as XR devices, digital signage, and TVs for convenience of description. However, it will be understood that other embodiments implemented by those skilled in the art by combining the examples of the following figures with each other by referring to the examples of the previous figures are also within the scope of the present disclosure.

Specifically, the multimedia device to be described in the following figures can be implemented as any of devices each having a display function without departing from the scope or spirit of the present disclosure, so that the multimedia device is not limited to the XR device and corresponds to the user equipment (UE) mentioned in FIGS. 1 to 14 and the multimedia device shown in the following figures can additionally perform 5G communication.

Particularly, as a device capable of a projector function of projecting to display an image on a projection body is enough for a multimedia device that will be described with reference to the accompanying drawings, the multimedia device is non-limited by an XR device.

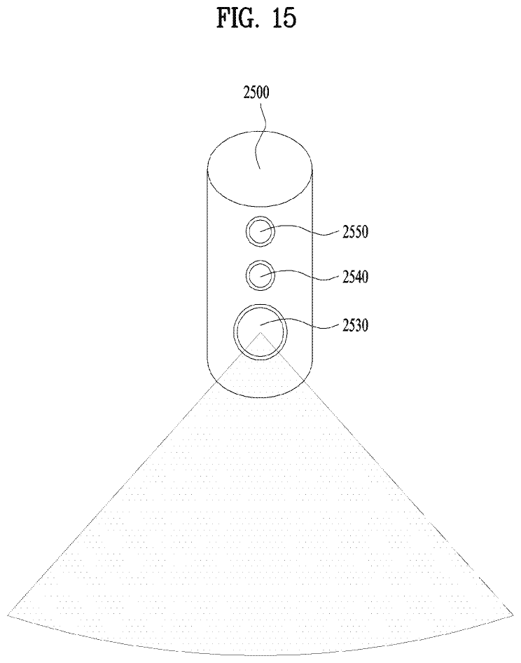

An XR device and method of controlling the same according to one embodiment of the present disclosure, which facilitate a user to use two or more control components by changing disposition of the control components depending on a state of a projection plane on which a virtual UI including the control components for the operation control of a communication-connected external device, will be described in detail with reference to FIGS. 15 to 29 as follows.

In some implementations, an XR device 2500 according to the present disclosure may include any device, to which XR technologies and image projecting functions are applied, such as an AR projector, a Head-Mounted Display (HMD), a Head-Up Display (HUD), eyeglass-type AR glasses, a smartphone, a tablet PC, a laptop, a desktop, a TV, a digital signage, etc.

The following description will be made on the assumption that the XR device 2500 according to the present disclosure includes an AR projector.

FIG. 15 is a diagram showing a case of implementing an XR device of an AR projector type according to one embodiment of the present disclosure.

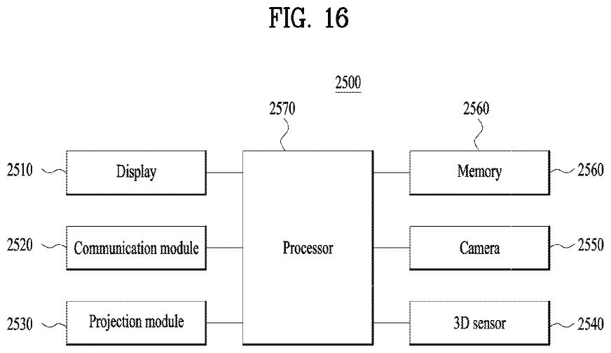

FIG. 16 is a block diagram of an XR device of an AR glass type for controlling an IoT device according to one embodiment of the present disclosure.

Referring to FIG. 15 and FIG. 16, an AR projector 2500 of the present disclosure includes a display 2510, a communication module 2520, a projection module 2530, a 3D sensor 2540, a camera 2550, a memory 2560, and a processor 2570.

The display 2510 includes a touchscreen type, and may display informations processed by the AR projector 2500 visually or an environment setting window of the AR projector 2500.

If the communication module 2520 connects communication with at least one external device by wire or wireless by being paired with the at least one external device, it transceives signals with the corresponding external device.

Here, according to the present disclosure, the external device may include an Internet-of-Things (IoT) device. If so, the AR projector 2500 may play a role as an IoT hub device configured to control the IoT device.

Namely, the AR projector 2500 may receive device information of an IoT device from at least one IoT device that is a control target, create a virtual UI including two or more control components for controlling operations of the IoT device based on the received device information, and project the virtual UI on a projection plane through the projection module 2530.

For example, if the external device is a multimedia device capable of reproducing a multimedia, the virtual UI may include control components for controlling at least one of operations including start of the multimedia, pause, next multimedia output, previous multimedia output, sound volume up/down, broadcast channel up/down, etc.

If an IoT application for controlling the at least one IoT device is installed and then executed, the AR projector 2500 connects communication with at least one IoT device registered at the IoT application and displays a list of the connected at least one IoT device. If a specific IoT device is selected from the list, the AR projector 2500 may project a virtual UI, which is to control an operation of the selected specific IoT device among virtual Uls provided by the application, on the projection plane.

The AR projector 2500 may receive status information indicating an operational status of the IoT device from the IoT device and project a virtual UI including the received status information.

For example, the status information may include at least one of information related to a currently operating function of the IoT device, an amount of power used by the IoT device for a preset period, and information related to an event currently occurring in the IoT device.

The AR projector 2500 may receive information, which is currently outputted from the IoT device, from the IoT device and project a virtual UI including the received information. The information may include at least one of a screen image of a specific function, a multimedia image, and a website image.

Meanwhile, the above-described communication module 2520 may include at least one of a mobile communication module, a wireless internet module, and a short-range communication module.

The mobile communication module transceives wireless signals with at least one of a base station, an IoT device, and a server on a mobile communication network established according to the technology standards or communication systems for mobile communications (e.g., GSM (Global System for Mobile communication), CDMA (Code Division Multi Access), WCDMA (Wideband CDMA), HSDPA (High Speed Downlink Packet Access), LTE (Long Term Evolution), 5G (5th Generation)). The wireless signals may include a voice call signal, a video call signal, and data of various types according to text/multimedia message transceiving. The mobile communication module may perform communication with an IoT device through at least one of mobile communication networks provided by the aforementioned communication systems.

The wireless internet mobile refers to a module for a wireless Internet access and may be built in or outside the AR projector 2500. The wireless internet module is configured to transceive wireless signals on communication networks according to the wireless Internet technologies.

The wireless internet technologies include, for example, WLAN (Wireless LAN), WiFi (Wireless Fidelity) Direct, DLNA (Digital Living Network Alliance), Wibro (Wireless broadband), Wimax (World Interoperability for Microwave Access), HSDPA (High Speed Downlink Packet Access), LTE (Long Term Evolution), etc. The wireless internet module 113 transceives data according to at least one wireless internet technology in a range including internet technologies failing to be listed in the above description.

From the perspective that a wireless internet access by Wibro, HSDPA, GSM, CDMA, WCDMA, LTE, or the like is achieved through a mobile communication network, the wireless internet module performing the wireless internet access through the mobile communication network may be understood as a sort of the mobile communication module. The wireless internet module may perform communication with an IoT device through at least one of the communication networks provided by the aforementioned wireless internet technologies.

The short range communication module is provided for short range communication and may support short range communication using at least one of Bluetooth, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct, etc. The short range communication module may perform communication with an IoT device through at least one of the communication networks provided by the aforementioned communication technologies.

The projection module 2530 projects a virtual UI, which includes the aforementioned control components, on a projection plane using light of a light source.

The 3D sensor 2540 is a sensor configured to scan a space of a projection plane on which the virtual UI is projected and sense a state of the projection plane, and may sense at least one state of a presence or non-presence of at least one object in a projection angle projected on the projection plane, a distance to the projection plane, a flat degree of the projection plane, and a curved extent of the projection plane.

The camera 2550 captures an image including a user's touch action on the control components within the virtual UI projected on the projection plane.

The memory 2560 is capable of a program related to an operation of the AR projector 2500, at least one application, an operating system, and various data such as user's personal data and the like, and may store virtual Uls for controlling operations of IoT devices according to the present disclosure.

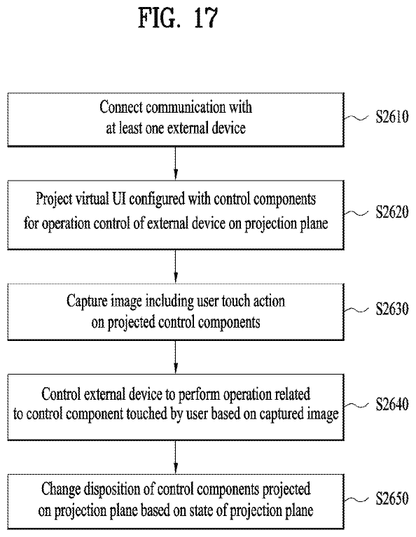

The processor 2570 2570 controls overall operations of the AR projector 2500 according to the present disclosure. A process for changing dispositions of control components according to a state of a projection plane, on which a virtual UI including the control components for the operation control of an IoT device is projected, is described in detail with reference to FIGS. 17 to 29 as follows.

FIG. 17 is a flowchart of a projection control process of a virtual UI of an AR projector according to one embodiment of the present disclosure.

Referring to FIG. 17, the processor 2570 connects communication with at least one IoT device through the communication module 2520 [S2610], and projects a virtual UI configured with control components for the operation control of the IoT device on a projection plane through the projection module 2530 [S2620].

The processor 2570 captures an image containing a user's touch action on the control components projected on the projection plane through the camera 2550 [S2630], and then controls the IoT device to perform an operation related to the control component touched by the user [S2640].

Subsequently, the processor 2570 senses a state of the projection plane on which the virtual UI is projected through the 3D sensor 2540, and then changes the disposition of the control components based on the sensed state of the projection plane [S2650].

Namely, the processor 2570 senses at least one state of a presence or non-presence of at least one object in a projection angle projected on the projection plane, a distance to the projection plane, a flat degree of the projection plane, and a curved extent of the projection plane through the 3D sensor 2540, and may change the disposition of the control components based on the sensing result.

In some implementations, the step S2650 may be performed after the step S2620 as well.

Hereinafter, a process for changing the disposition of the control components based on the sensed state of the projection plane is described in detail with reference to FIGS. 18 to 29.

FIG. 18 is a diagram to describe a process for projecting a virtual UI according to one embodiment of the present disclosure.

Referring to FIG. 18, if communication with an IoT device 2410 is connected [FIG. 18 (a)], the processor 2570 may project a virtual UI 2700 including control components 2710, 2720 and 2730 for the operation control of the IoT device 2410 on a projection plane 2700P through the projection module 2530 [FIG. 18 (b)].

In doing so, as shown in FIG. 18 (a), if an input of a preset motion gesture is detected from a user based on an image received through the camera 2550, the processor 2570 may control the virtual UI 2700 to be projected.

For example, FIG. 18 shows that the IoT device 2410 is a TV, and that a first control component 2710 for the sound volume up/down control, a second control component 2720 for the power on/off control of the TV 2410, and a third control component 2730 for the broadcast channel switching are included in the virtual UI 2700. Of course, the types of the first to third control components 2710, 2720 and 2730 are just exemplary. And, all the control components corresponding to keys provided to a remote controller for the control of the TV may be included in the virtual UI 2700.

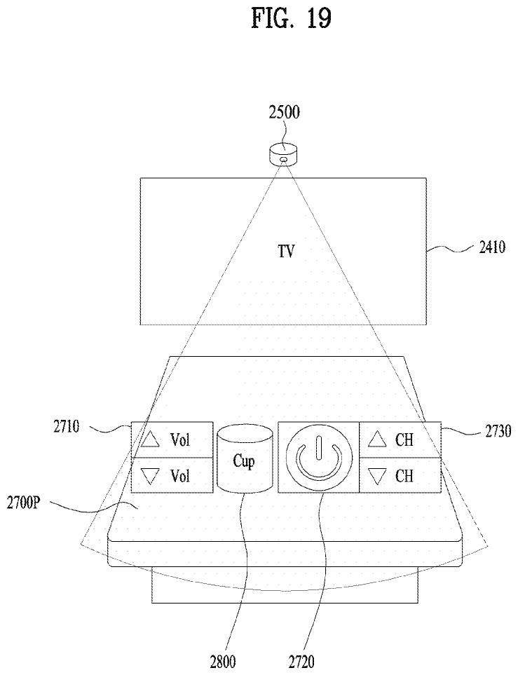

FIG. 19 is a diagram to describe a process for projecting control components within a virtual UI in a manner of avoiding an object according to one embodiment of the present disclosure.

Referring to FIG. 19, the processor 2570 scans a position, on which a virtual UI for the operation control of the IoT device 2410 will be projected, within a projection plane 2700P through the 3D sensor 2540. As a result of the scan, if it is sensed that an object 2800 other than a user's hand exists at the position on which the virtual UI will be projected, the processor 2570 may change the disposition of control components 2710, 2720 and 2730 within the virtual UI so as to enable the control components 2710, 2720 and 2730 to be projected in a manner of avoiding the object 2800.

For example, FIG. 19 shows that the first control component 2710 among the control components 2710, 2720 and 2730 is separated and disposed in a manner of avoiding the object 2800.

In addition, if the object exists at the position on which the virtual UI will be projected, the processor 2570 may determine whether the control components 2710, 2720 and 2730 are projective entirely or in part, and then project the control components 2710, 2720 and 2730 on the object entirely or in part according to a result of the determination.

Namely, based on the sensing result of the projection plane 2700P of the 3D sensor 2540, if it is determined that a surface of the object 2800 is not flat within a preset reference, the processor 2570 may control the control component 2710 among the control components 2710, 2720 and 2730 to be separated and projected by avoiding the object 2800.

On the contrary, based on the sensing result of the projection plane 2700P of the 3D sensor 2540, if it is determined that a surface of the object 2800 is flat within a preset reference, the processor 2570 may control the control components 2710, 2720 and 2730 to projected on the object 2800 entirely or in part.

The processor 2570 measures a surface reflectance off the object through the 3D sensor 2540 (or s surface reflection measurement sensor provided to an AR projector). As the measured surface reflectance of the object is lower than a preset reference value, if a material of the object is sensed as a transparent material such as glass or plastic, the control components 2710, 2720 and 2730 can pass through the object. Hence, the processor 2570 may change the disposition of the control components so that the control components can be projected entirely or in part by avoiding the object.

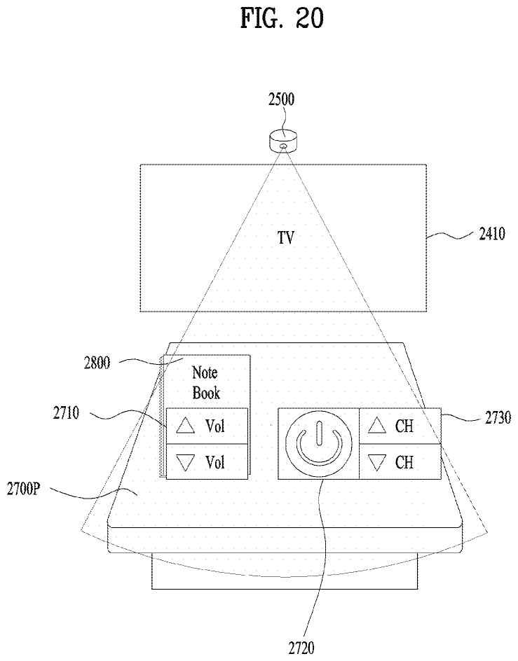

FIG. 20 is a diagram to describe a process for projecting some of control components within a virtual UI on an object according to one embodiment of the present disclosure.

Referring to FIG. 20, the processor 2570 scans a position, on which a virtual UI for the operation control of the IoT device 2410 will be projected, within a projection plane 2700P through the 3D sensor 2540. As a result of the scan, if it is sensed that an object 2900 other than a user's hand exists at the position on which the virtual UI will be projected, the processor 2570 determines whether a surface of the object 2900 is flat within a range of a preset reference through the 3D sensor 2540.

If it is determined that the surface of the object 2900 is flat within a range of the preset reference through the 3D sensor 2540, the processor 2570 controls the control components 2710, 2720 and 2730 to be projected and displayed on the object 2900 entirely or in part.

In doing so, when the object 2900 is an object with prescribed thickness, if some 2710 of the control components 2710, 2720 and 2730 is projected on the object 2900, there may be a height difference between the control component 2710 and the rest of the control components 2720 and 2730, whereby the control components 2710, 2720 and 2730 may be viewed distortedly.

Therefore, the processor 2570 may control the control component 2710, which overlaps with the object 2900, among the control components 2710, 2720 and 2730 to be projected on the object 2710 by being separated from the rest of the control components 2720 and 2730.

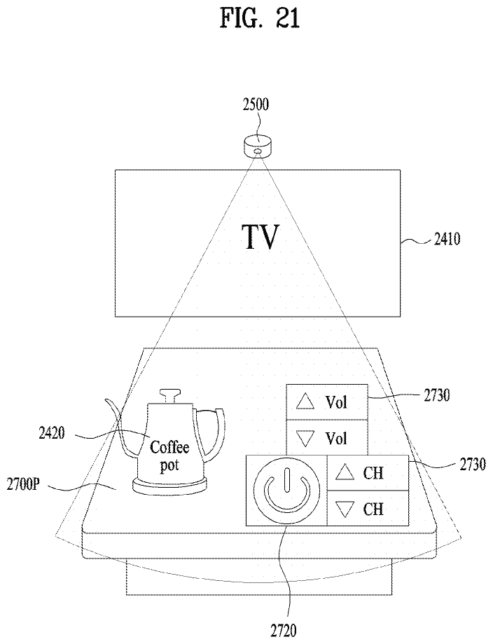

FIG. 21 is a diagram showing a process for projecting some of control components within a virtual UI in a manner of avoiding a dangerous object according to one embodiment of the present disclosure.

Referring to FIG. 21, the processor 2570 scans a position, on which a virtual UI for the operation control of the IoT device 2410 will be projected, within a projection plane 2700P through the 3D sensor 2540. As a result of the scan, if it is sensed that an object 2420 other than a user's hand exists at the position on which the virtual UI will be projected, the processor 2570 determines whether the object 2420 is a dangerous object.

For one example, the processor 2570 recognizes the object 2420 in the image captured by the camera 2550. If the recognized object 2420 corresponds to a preset dangerous object, the processor 2570 may regard the object 2420 as a dangerous object.

For another example, when the object 2420 is an IoT device, if an operational status of the IoT device satisfies a preset condition based on the IoT device's operational status information received from the IoT device, the processor 2570 may regard the IoT device as a dangerous object.

For example, when the IoT device is an IoT coffee port, if water temperature information of the IoT coffee port 2420 received through the communication module 2520 belongs to a preset temperature range (e.g., a water temperature range enough to scald a user), the processor 2570 may regard the IoT coffee port 2420 as a dangerous object.

As described above, if the object 2420 is determined as a dangerous object, the processor 2570 may change disposition of the control components 2710, 2720 and 2730 so that the control components 2710, 2720 and 2730 within the virtual UI can be projected by avoiding the object 2420.

For example, FIG. 21 shows that the first control component 2710, of which position overlaps with the object 2420, among the control components 2710, 2720 and 2730 is separated and disposed by avoiding the object 2800.

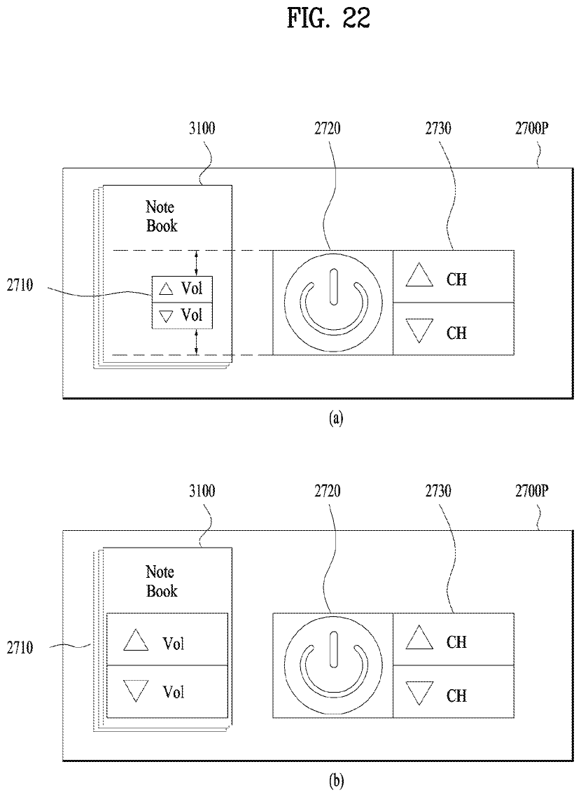

FIG. 22 is a diagram to describe a process for enlarging and projecting some of control components within a virtual UI according to one embodiment of the present disclosure.

Referring to FIG. 22, the processor 2570 sense4s a distance to a projection plane 2700P through the 3D sensor 2540, and may adjust a projection size of some 2710 of the control components 2710, 2720 and 2730 based on the sensed distance.

Namely, the projection plane 2700P may include a first region on which the control component 2710 among the control components 2710, 2720 and 2730 is projected and a second region on which the second and third control components 2720 and 2730 are projected.

In this case, if determining that there is a distance difference between the first and second regions based on the sensing result of the 3D sensor 2540, the processor 2570 may adjust a projection size of the first control component 2710 projected on the first region and or projection sizes of the second and third control components 2720 and 2730 differently based on the distance difference.

For example, as shown in FIG. 22 (a), the projection plane 2700P may include a first region and a second region. in this case, an object 3100 on which the first control component 2710 among the control components 2710, 2720 and 2730 can be projected is put in the first region. And, the second and third control components 2720 and 2730 are projected on the second region while any object is not put in the second region.

Here, a size of the first control component 2710 projected on the object 3100 in the first region becomes smaller than a size of each of the second and third control components 2720 and 2730 projected on the second region having no object put therein due to a height of the object 3100.

Therefore, as shown in FIG. 22 (b), according to the distance difference between the first and second regions due to the height of the object 3100, the processor 2570 may project the first control component 2710 on the object 3100 in the first region in a manner of enlarging a size of the first control component 2710 to be larger than the second and third control components 2720 and 2730 projected on the second region.

Namely, as if the control components 2710, 2720 and 2730 are projected on a plane (i.e., a flat surface), the processor 2570 corrects a size and position of the first control component 2710 by the distance difference generated due to the height of the object 3100.

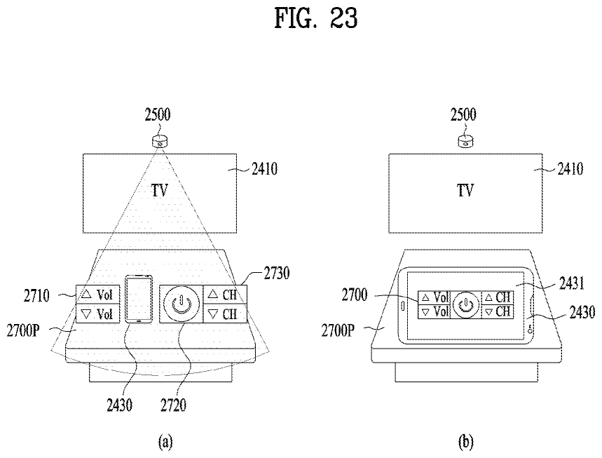

FIG. 23 is a diagram to describe a process for displaying a virtual UI on an external device having a screen according to one embodiment of the present disclosure.

Referring to FIG. 23 (a), the processor 2570 scans a position, on which a virtual UI 2700 for the operation control of the IoT device 2410 will be projected, within a projection plane 2700P through the 3D sensor 2540. As a result of the scan, if it is sensed that an object 2430 other than a user's hand exists at the position on which the virtual UI will be projected, the processor 2570 may change the disposition of control components 2710, 2720 and 2730 within the virtual UI so that the control components 2710, 2720 and 2730 can be projected by avoiding the object 2430.

For example, FIG. 23 (a) shows that the first control component 2710 among the control components 2710, 2720 and 2730 is separated and disposed in a manner of avoiding the object 2800.

In this case, when communication is connected between the object 2430 and the AR projector 2500, if the object 2430 is an external device 2430 having a screen 2431, as shown in FIG. 23 (b), the processor 2570 may control the virtual UI 2700 including the control components 2710, 2720 and 2730 to be displayed on the screen 2431 of the external device 2430.

Specifically, when the external device 2430 having the screen 2431 is recognized through the camera 2550, if a first motion of a user gripping the external device 2430 is sensed, the processor 2570 may control the projection module 2530 to stop a projection operation of the virtual UI 2700 and control the external device 2430 to display the virtual UI 2700 on the screen 2431 [FIG. 23 (b)].

In doing so, the processor 2570 provides graphic data corresponding to the virtual UI 2700 to the external device 2430 through the communication module 2520, thereby controlling the external device 2430 to display the virtual UI 2700 on the screen 2431.

In some implementations, the first motion may include a motion that the user grips the external device 2430 and then lifts it up from the projection plane 2700P.

In order to display information indicating an operational status of the IoT device 2410 on the external device 2430 as well as the graphic data corresponding to the virtual UI 2700, the processor 2570 may transmit graphic data corresponding to the operational status information to the external device 2430 as well. For example, the operational status information may include at least one of information related to a currently operating function of the IoT device 2410, an amount of power used by the IoT device 2410 for a preset period, and information related to an event currently occurring in the IoT device 2410.

The processor 2570 may receive information, which is currently outputted from the IoT device 2410, from the IoT device 2410 and transmit graphic data corresponding to the received information to the external device 2430 as well as the graphic data corresponding to the virtual UI 2700 and the graphic data corresponding to the operational status information.

If sensing a second motion of the user gripping the external device 2430 through the camera 2550, the processor 2570 may control the external device 2430 to stop displaying the virtual UI 2700 displayed on the screen 2431 and control the projection module 2530 to project the virtual UI 2700 on the projection plane 2700P again.

Specifically, if sensing that the motion of the user griping the external device 2430 is changed into the second motion from the first motion through the camera 2550, the processor 2570 may control the external device 2430 to stop displaying the virtual UI 2700 displayed on the screen 2431 and control the projection module 2530 to project the virtual UI 2700 on the projection plane 2700P again.

Here, the second motion may include a motion of switching a state that the external device 2430 is lifted up from the projection plane P by the user to a state that the external device 2430 is put down on the projection plane 2700P again.

In this case, if the external device 2430 is put at a specific position of the projection plane 2700P, the processor 2570 may control the control components 2710, 2720 and 2730 of the virtual UI 2700 to be disposed by avoiding the external device 2430.

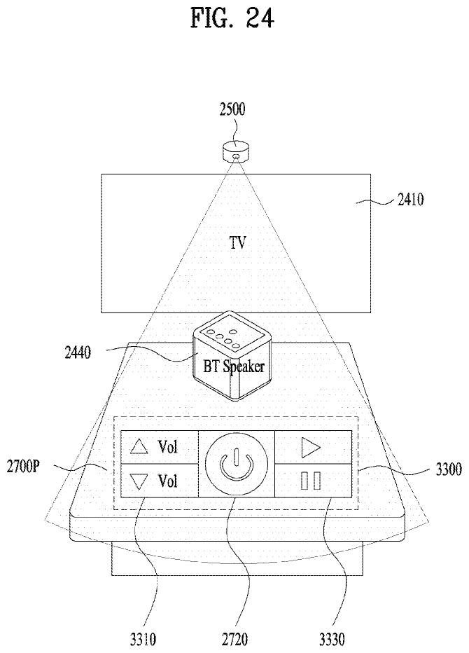

FIG. 24 is a diagram to describe a process for projecting a virtual UI to control a non-screen external device located in a projection plane according to one embodiment of the present disclosure.

Referring to FIG. 24, the processor 2570 recognizes an object 2440 put on a projection plane 2700P and may control a virtual UI 3300 related to the recognized object 2440 to be projected on the projection plane.

Here, the object 2440 may include a non-screen external device 2440 communication-connectible with the AR projector 2500. For example, the external device 2440 having no screen may include a wireless speaker, an air cleaner, a humidifier, etc.

If recognizing the non-screen external device 2440 through the camera 2550, the processor 2570 searches the memory 2560 for the virtual UI 3300 of the recognized external device 2440 and may project the found virtual UI 3300 on the projection plane 2700P.

Here, the virtual UI 3300 of the external device 2440 may include at least one of two or more control components 3310, 3320 and 3330 for the operation control of the external device 2440, operational status information of the external device 2440, and information related to sound currently outputted from the external device 2440. The operational status information may include at least one of information related to a currently operating function of the external device 2440, an amount of power used by the external device 2440 for a preset period, and information related to an event currently occurring in the external device 2440.

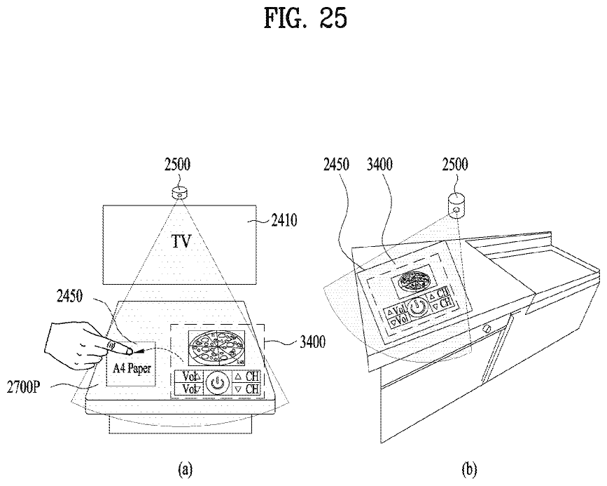

FIG. 25 is a diagram to describe a process for linking a virtual UI to an object according to one embodiment of the present disclosure.

Referring to FIG. 25 (a), while a virtual UI 3400 of an IoT device 2410 is projected by avoiding an object 2450 put in a projection plane 2700P, if a user's motion gesture that the virtual UI 3400 is moved to the object 2450 is recognized through the camera 2550, the processor 2570 saves an image of the recognized object 2450 to the memory 2560 in a manner of mapping the image and the virtual UI 3400 to each other.

Here, the virtual UI 3400 may include two or more control components for the operation control of the IoT device 2410, operational status information of the IoT device 2410, and a content currently outputted from the IoT device 2410. The operational status information may include information related to a currently operating function of the IoT device 2410, an amount of power used by the IoT device 2410 for a preset period, and information related to an event currently occurring in the IoT device 2410. And, the content may include at least one of information, video, music, and text outputted from the IoT device 2410.

Thereafter, referring to FIG. 25 (b), if recognizing the object 2450 again through the camera 2550, the processor 2570 projects the virtual UI 3400 mapped to the image of the recognized object 2450 in the memory 2560 to the projection plane again.

Namely, after the user has moved the currently projected virtual UI 3400 to the object 2450, if the object 2450 is recognized again through the camera 2550, the AR projector 2500 projects the virtual UI 3400 on the object 2450, thereby providing it to the user.

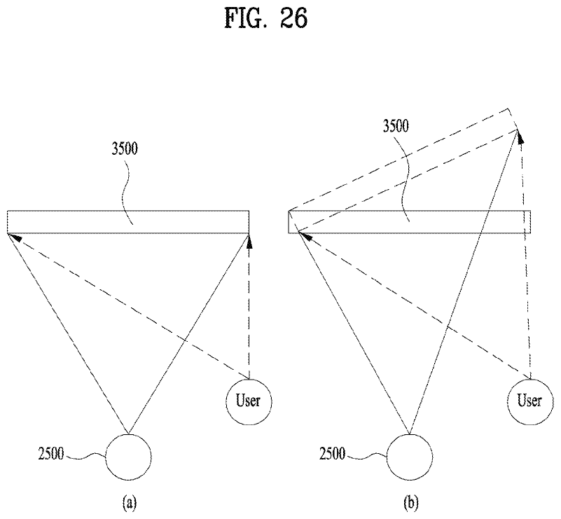

FIG. 26 is a diagram to describe a process for changing a projection angle of a virtual UI depending on a user's location according to one embodiment of the present disclosure.

Referring to FIG. 26 (a), an AR projector 2500 is projecting a virtual UI in a forward direction to a projection plane 3500. And, a user is located not in the forward direction to the projection plane 3500 but on one side of the AR projector 2500.

In this case, when the user looks at the virtual UI projected on the projection plane 3500, there is a problem that the virtual UI looks distortedly due to the user's location toward the projection plane 3500.

Therefore, as shown in FIG. 26 (b), if recognizing the user while projecting the virtual UI on the projection plane 3500, the processor 2570 obtains a location of the recognized user and may change a projection angle of the virtual UI so that the virtual UI projected on the projection plane 3500 can be viewed in a forward direction from the user's location. Here, the camera 2550 may include a military-wave camera capable of user's location recognition.

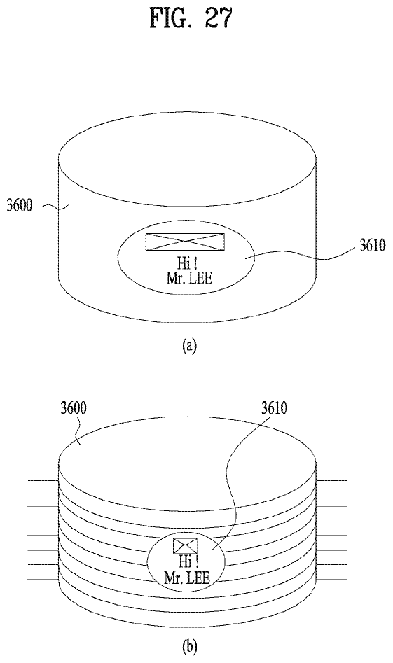

FIG. 27 is a diagram to describe a process for projecting a virtual UO on a material of a curved projection plane according to one embodiment of the present disclosure.

Referring to FIG. 27 (a), before a virtual UI 3610 is projected on a projection plane 3600, the processor 2570 senses depth information on a surface of the projection plane 3600 through the 3D sensor 2540 and analyzes a curved state of the surface of the projection plane 3600 based on the sensed depth information.

Based on the analyzed curved state, if the surface of the projection plane 3600 is determined as curved more than a preset reference, as shown in FIG. 27 (b), the processor 2570 projects the virtual UI 3610 in a manner of correcting the virtual UI 3610 so as not to be distorted by the curved surface of the projection plane 3600.

For example, as shown in FIG. 27 (a), if the virtual UI 3610 is projected on the projection plane 3610 having a rounded surface, the virtual UI 3610 is distorted in a manner of being stretched horizontally due to the rounded surface.

Therefore, referring to FIG. 27 (b), although the projection plane 3610 has the rounded surface, the processor 2570 corrects the shape of the virtual UI 3610 so as to be viewed without distortion.

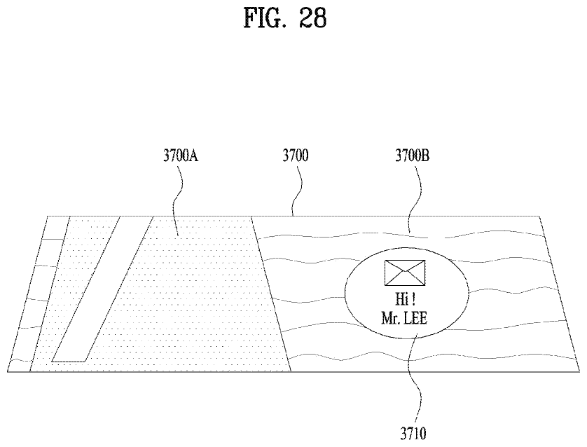

FIG. 28 is a diagram to describe a process for changing a projection position of a virtual UI depending on a material of a projection plane according to one embodiment of the present disclosure.

Referring to FIG. 28, before projecting a virtual UI 3710 on a projection plane 3700, the processor 2570 measures a surface reflectance of a whole region of the projection plane 3700 through the 3D sensor 2540 (or a surface reflection measurement sensor provided to an AR projector).

As a result of the measurement of the surface reflectance, if a surface reflectance of a first region 3700A of the projection plane 3700 corresponds to a transparent material lower than a preset reference and a surface reflectance of a second region 3700B of the projection plane 3700 corresponds to a non-transparent material lower than the preset reference, the processor 2570 controls the virtual UI 3710 to be projected on the second region 3700B of the non-transparent material by avoiding the first region 3700A of the transparent material.

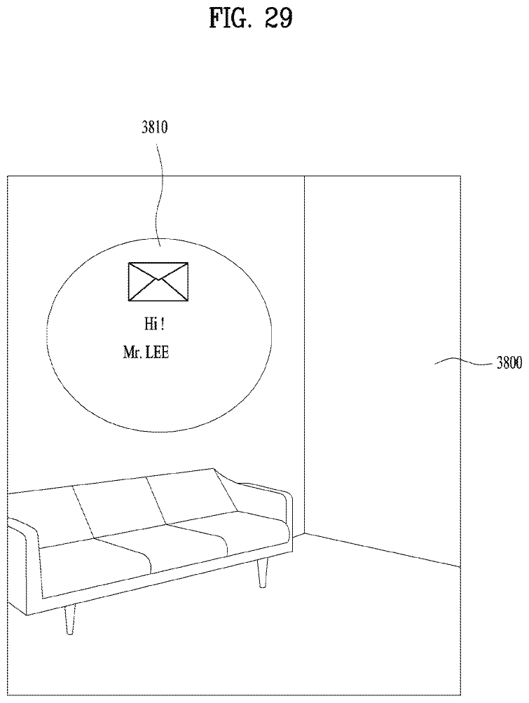

Finally, FIG. 29 is a diagram to describe a process for changing a display style of a virtual UI depending on a material color of a projection plane according to one embodiment of the present disclosure.

Referring to FIG. 29, before projecting a virtual UI 3810 on a projection plane 3800, the processor 2570 senses a material color of the projection plane 3800 through the camera 2550 and may change a display style of the virtual UI 3810 based on the sensed material color of the projection plane 3800.

For one example, the processor 2570 changes a color of the virtual UI 3810 into a color contrary to the sensed material color of the projection plane 3800, thereby enabling the virtual UI 3810 to be seen well in the projection plane 3810.

For another example, the processor 2570 changes a color of the virtual UI 3810 into a color matching with the sensed material color of the projection plane 3800, thereby enabling the virtual UI 3810 to be seen in harmony with the projection plane 3810.

According to one of various embodiments of the present disclosure, depending on a state of a projection plane on which a virtual UI including two or more control components for the operation control of a communication-connected external device is projected, the disposition of the control components is changed, whereby a user may conveniently use the control components.

According to another one of various embodiments of the present disclosure, when an object exists at a location on which the virtual UI will be projected in a projection plane, the control components are projected in a manner of avoiding the object, whereby a user may conveniently use the control components without removing the object from the projection plane.

Although the present specification has been described with reference to the accompanying drawing, it will be apparent to those skilled in the art that the present specification can be embodied in other specific forms without departing from the spirit and essential characteristics of the specification. The scope of the specification should be determined by reasonable interpretation of the appended claims and all change which comes within the equivalent scope of the specification are included in the scope of the specification.

What is claimed is:

1. An XR device, comprising:
a communication module configured to communicate with at least one external device;
a projection module configured to project a virtual User Interface (UI) including a plurality of control components for operation control of the external device on a projection plane;
a camera configured to receive an image including a touch action of a user on the control components projected on the projection plane; and
a processor operably coupled with the communication module, the projection module and the camera, and configured to:
control the external device to perform an operation related to the control component touched by the user based on the received image, and
change disposition of the control components based on a state of the projection plane.

2. The XR device of claim 1, wherein the external device includes an Internet-of-Things (IoT) device and wherein the XR device includes an IoT hub device controlling the IoT device.

3. The XR device of claim 1, further comprising:
a 3D sensor configured to sense the state of the projection plane,
wherein the processor is further configured to change the disposition of the control components based on the sensed state of the projection plane.

4. The XR device of claim 3, wherein when determining that an object exists at a position on which the virtual UI will be projected in the projection plane based on the sensing result of the 3D sensor, the processor changes the disposition of the control components so that the control components are projected by avoiding the object.

5. The XR device of claim 4, wherein when determining that the surface of the object is not flat within a preset reference based on the sensing result of the 3D sensor, the processor changes the disposition of the control components so that the control components are projected by avoiding the object.

6. The XR device of claim 4, wherein when sensing that the object includes a material transparent over a preset reference based on the sensing result of the 3D sensor, the processor changes the disposition of the control components so that the control components are projected by avoiding the object.

7. The XR device of claim 3, wherein the processor is further configured to:
sense a distance to the projection plane through the 3D sensor, and
adjust a projection size of a prescribed one of the control components based on the sensed distance.

8. The XR device of claim 7, wherein the projection plane includes a first region on which the prescribed one of the control components is projected and a second region on which the rest of the control components are projected and wherein when determining that there is a distance difference between the first region and the second region based on the sensing result of the 3D sensor, the processor adjusts a projection size of the control component projected on the first or second region differently.

9. The XR device of claim 4, wherein when the object comprises a different external device communication-connected to the XR device, the processor controls the different external device to display the virtual UI on a screen.

10. The XR device of claim 9, wherein when sensing a first motion related to the different external device through the camera, the processor controls the projection module to stop a projection operation of the virtual UI and control the different external device to display the virtual UI on the screen.

11. The XR device of claim 10, wherein when sensing a second motion related to the different external device through the camera, the processor controls the different external device to stop a display operation of the virtual UI and controls the projection module to project the virtual UI on the projection plane again.

12. The XR device of claim 4, wherein the processor recognizes the object through the camera and controls a virtual UI related to the recognized object to be projected on the projection plane.

13. The XR device of claim 4, wherein the processor recognizes the object through the camera and controls content related to the recognized object to be projected on the projection plane.

14. The XR device of claim 3, wherein the processor obtains a location of a user staring at the projection plane and changes a projection angle of the virtual UI so that the virtual UI projected on the projection plane is viewed in a forward direction from the location of the user.

15. The XR device of claim 3, wherein when determining that the projection plane is curved over a preset reference based on the sensing result of the 3D sensor, the processor controls the control components not to be projected by being distorted by a curve of the projection plane.

16. The XR device of claim 3, wherein the processor senses a material color of the projection plane through the camera and changes a display style of the control components based on the sensed material color.

17. A method of controlling an XR device, the method comprising:
establishing, via a communication module, communication with at least one external device;
projecting, via a projection module, a virtual User Interface (UI) including a plurality of components for operation control of the external device on a projection plane;
receiving, via a camera, an image including a touch action of a user on the control components projected on the projection plane;
controlling the external device to perform an operation related to the control component touched by the user based on the captured image; and
changing disposition of the control components projected on the projection plane based on a state of the projection plane.

18. The method of claim 17, further comprising sensing the state of the projection plane through the 3D sensor, wherein the changing the disposition comprises changing the disposition of the control components based on the sensed state of the projection plane.

19. The method of claim 18, wherein the changing the disposition comprises, if determining that an object exists at a position on which the virtual UI will be projected in the projection plane based on the sensing result of the 3D sensor, changing the disposition of the control components so that the control components are projected by avoiding the object.

20. The method of claim 17, further comprising:
sensing a distance to the projection plane through the 3D sensor; and
adjusting a projection size of the control components based on the sensed distance.
